(19) United States
(12) Patent Application Publication
(10) Pub. No.: US 2024/0387868 A1
(43) Pub. Date: Nov. 21, 2024

(54) High Performance Solid-State Electrolyte and Battery based on Cyanoethylated Polymers and Additives and Manufacturing Method Thereof

(71) Applicant: Nuvvon, Inc., Bordentown, NJ (US)

(72) Inventor: Manveer S. Sidhu, Levittown, PA (US)

(21) Appl. No.: 18/652,565

(22) Filed: May 1, 2024

Related U.S. Application Data
(60) Provisional application No. 63/503,407, filed on May 19, 2023.

(51) Int. Cl. H01M 10/0565; H01M 4/525; H01M 10/058

(52) U.S. Cl. CPC H01M 10/0565; H01M 4/525; H01M 10/058; H01M 2300/0082

(57) ABSTRACT

A polymer electrolyte including a polymer host, a boron-containing lithium salt, and a plasticizer. In some embodiments, the polymer host may be a cyanoresin. An example is a cyanoethyl polyvinyl alcohol. In various embodiments, the lithium salt is a lithium difluoro(oxalato)borate or a lithium bis(oxalato)borate. And in other embodiments, the plasticizer may be a succinonitrile. The polymer host, the boron-containing lithium salt, and the plasticizer are formed into a free-standing membrane. The polymer electrolyte functions as a catholyte in a composite cathode with various cathode active materials including lithium iron phosphate, lithium nickel manganese cobalt oxide, and lithium nickel manganese oxide. In another aspect of the disclosure, the polymer electrolyte is formed as a polymer electrolyte separator on the composite cathode. A rechargeable battery cell comprising the composite cathode and the polymer electrolyte separator using the polymer electrolyte.

### CROSS REFERENCE TO RELATED APPLICATION

This application claims priority under 35 U.S.C. § 119 (e) to U.S. Provisional Patent Application No. 63/503,407 filed on May 19, 2023, which is incorporated by reference herein in its entirety.

### BACKGROUND

The present disclosure relates to the field of electrochemical cells, including electrolyte materials, electrodes, and other components used in electrochemical cells.

Solid state lithium-ion batteries (“solid state batteries”) use a solid electrolyte as opposed to a liquid electrolyte. Solid state batteries may also use solid electrolyte in combination with liquid electrolytes or other non-solid components. Solid state batteries generally have higher energy density than comparable lithium-ion batteries built with a liquid electrolyte. Solid state batteries are also intrinsically safer than lithium-ion batteries that utilize liquid electrolytes because solid electrolytes are not as flammable as liquid electrolytes. Polymers are highly suited to fabricating solid electrolytes due to their low flammability, processability, flexibility, structural stability, thermal stability, and wide electrochemical stability window. The present disclosure relates to polymer electrolytes and lithium-ion rechargeable battery cells with polymer electrolyte based components.

Conventional polymer electrolytes utilize a polymer known as polyethylene oxide (PEO) as the polymer host. PEO can be a polymer host for solid polymer electrolytes as it is economical, can be readily made into films, and has strong solvating properties for a variety of lithiated salts. However, due to the semicrystalline structure of pristine PEO, PEO-based polymer electrolytes exhibit low ionic conductivity at room temperature (10⁻⁸ to 10⁻⁶ S/cm), which is not practical for lithium-ion batteries. Explained differently, PEO used in convention polymer electrolytes exhibit low dielectric constants (typically less than 5). Low dielectric constants increase the ion association in polymer electrolytes, which results in unacceptably low concentrations of charge carriers, hence decreasing ionic conductivity.

To achieve the necessary level of ionic conductivity, the operating temperature of PEO-based polymer electrolytes must be raised above PEO's melting point (>65° C.) so the semicrystalline regions become amorphous. This operating temperature requirement restricts the practical application of the cell. The higher operating temperature also creates other problems since higher temperatures lead to softer polymeric membranes, which can increase the likelihood of short-circuits. Efforts to reduce the semicrystalline regions of PEO at room temperature through the addition of plasticizers, solvents, and other additives tend to result in films with poor mechanical strength and/or safety and are not suitable for large scale manufacturing. Polymer electrolytes formulated using other polymers such as polyacrylonitrile (PAN) and polyvinyl pyrrolidone (PVP) also suffer from poor ionic conductivity.

The subject matter claimed herein is not limited to embodiments that solve any disadvantages or that operate only in environments such as those described above. Rather, this background is only provided to illustrate one example technology where some embodiments described herein may be practiced.

### SUMMARY

In one aspect of the disclosure, a polymer electrolyte is provided, the polymer electrolyte including a polymer host, a boron-containing lithium salt and a plasticizer. In some embodiments, the polymer host may be a cyanoethylated polymer, also known as cyanoresin. An example is a cyanoethyl polyvinyl alcohol. In some embodiments, the lithium salt is a lithium difluoro(oxalato)borate. Yet in another embodiment, the lithium salt is a lithium bis(oxalato)borate. And in other embodiments, the plasticizer may be a succinonitrile. According to various embodiments, the polymer electrolyte may be made up of 20 wt % (weight percentage) to 40 wt % of the cyanoethylated polymer such as cyanoresin. According to other embodiments, the polymer electrolyte may also be made up of 2.5 wt % to 15.0 wt % of the lithium difluoro (oxalate) borate or the lithium bis(oxalate) borate. Yet in other embodiments, the polymer electrolyte is made up of 45.0 wt % to 72.5 wt % of the succinonitrile. The polymer electrolyte has an ionic conductivity of 1×10⁻⁵ S/cm or greater. The polymer host, the boron-containing lithium salt, and the plasticizer can be formed into a free-standing membrane.

The polymer electrolyte may further contain an isophthalonitrile. In some embodiments, isophthalonitrile and 2-cyanoethyl ether are added as additives to the polymer electrolyte. In another embodiment, the polymer electrolyte contains an isophthalonitrile and a 1,3-Bis(cyanopropyl)tetramethyldisiloxane as additives. Yet in another embodiment, isophthalonitrile, 1,3-Bis(cyanopropyl)tetramethyldisiloxane, and 3,3′-Thiodipropionitrile are added to the polymer electrolyte.

Another aspect of the disclosure relates to a method of manufacturing a polymer electrolyte, including dissolving a polymer host in a first organic solvent; heating the polymer host to promote dissolution of the polymer host in the organic solvent to form a polymer host mixture; drying a boron-containing lithium salt at a temperature to remove moisture to form a substantially dried boron-containing lithium salt; dissolving a plasticizer in a second organic solvent to form a plasticizer mixture; heating the plasticizer mixture; adding the dried boron-containing lithium salt to the plasticizer mixture to obtain a first mixture; mixing the polymer host mixture to the first mixture to obtain a polymer electrolyte mixture comprising the polymer host, the boron-containing lithium salt, and the plasticizer. The boron-containing lithium salt may be heated to 80° C. to 120° C. to remove any moisture.

Another aspect of the disclosure provides for a composite cathode including the polymer electrolyte as described above mixed with a cathode active material, a carbon black, and a polyvinylidene fluoride binder, mixture formed as a cathode film on a current collector. In this aspect of the disclosure, the polymer electrolyte functions as a catholyte. In some embodiments, the cathode active material is a lithium iron phosphate. In another embodiment, the cathode active material is a NMC811. Yet in another embodiment, the cathode active material is a lithium nickel manganese oxide.

Another aspect of the disclosure provides for the polymer electrolyte described above functioning as a polymer electrolyte separator. An electrode stack is provided, the electrode stack including a positive current collector layer; a cathode layer is formed on a current collector layer; the polymer electrolyte separator layer includes the constituent components as described above; the polymer electrolyte separator layer is formed on the cathode film layer by solution casting; an anode layer separated from the cathode layer by the polymer electrolyte layer; and wherein the anode layer is formed on a negative current collector. In another embodiment the polymer electrolyte separator, as a free-standing membrane, can be formed on another substrate, peeled off, and dry placed on the cathode film layer.

Yet another aspect of the disclosure provides for manufacturing a composite cathode. A polymer electrolyte is prepared as described above. The polymer electrolyte is mixed with a cathode active material, a carbon containing material, and a polyvinylidene fluoride binder to form a slurry mixture; the slurry mixture is solution cast on a current collector; the slurry mixture is spread using a doctor blade on the current collector to form a cathode film layer; removing any solvent remaining in the cast slurry mixture; and calendaring the cathode film layer and the current collector.

One aspect of the disclosure also provides for a method of manufacturing the polymer electrolyte separator. A polymer electrolyte is prepared as described above. The polymer electrolyte is then deposited onto the composite cathode manufactured using a solution casting method to form the polymer electrolyte separator. The polymer electrolyte separator can also be separately formed and then integrated with the composite cathode by dry placement.

Another aspect of the disclosure is related to an electrode sub-stack that includes the composite cathode and the polymer electrolyte separator as described above. The electrode sub-stack also includes an anode layer formed on a negative current collector to form an anode. The anode, polymer electrolyte separator, and composite cathode together form the sub-stack. Multiple sub-stacks can be used together to form an electrode stack. In one example, up to 8 sub-stacks can be used.

Another aspect of the disclosure provides for a rechargeable battery cell with a cathode layer formed on a first current collector to form a positive electrode where the cathode layer is a composite cathode; an anode layer formed on a second current collector to form a negative electrode where the anode layer is a lithium metal; a polymer electrolyte separator separating the positive electrode and the negative electrode; and nickel tabs welded to the current collectors. The positive electrode, negative electrode, and polymer electrolyte separator are formed into an electrode sub-stack, and a plurality of such electrode sub-stacks are formed into a full electrode stack; and the full electrode stack is sealed in an insulating body.

Yet another aspect of the disclosure provides for a method of manufacturing a rechargeable battery cell, including casting a cathode layer on a first current collector to form a positive electrode, where the cathode layer is a composite cathode; depositing an anode layer on a second current collector to form a negative electrode, where the anode layer is a lithium metal; forming a polymer electrolyte separator layer on the cathode layer; stacking the anode layer facing the polymer electrolyte separator layer; welding nickel tabs to the first current collector and the second current collector; stacking the positive electrode, negative electrode, and polymer electrolyte separator to form an electrode sub-stack; stacking a plurality of electrode sub-stacks to form a full electrode stack; and sealing the full electrode stack sealed in an insulating body.

These and other aspects are described further below with reference to the figures.

### BRIEF DESCRIPTION OF THE DRAWINGS

FIG. 1 is a chart showing measurements of the transference number of a polymer electrolyte of the present disclosure.

FIG. 2 is a chart showing measurements of the transference number of a polymer electrolyte of the present disclosure.

FIG. 3 is a flow chart showing the steps of preparing a polymer electrolyte and preparing a composite cathode based on the polymer electrolyte according to an embodiment of the present disclosure.

FIG. 4A is a perspective view illustrating the preparation of a polymer electrolyte mixture according to an embodiment of the present disclosure.

FIG. 4B is a perspective view illustrating the preparation of a slurry mixture to form a composite cathode according to an embodiment of the present disclosure.

FIG. 4C is a side view illustrating the solution casting and doctor blading of a slurry mixture to form a composite cathode according to an embodiment of the present disclosure.

FIG. 4D is a side view illustrating the solution casting and doctor blading of a slurry mixture to form a composite cathode according to an embodiment of the present disclosure.

FIG. 4E illustrates the slurry mixture on the composite cathode after doctor blading according to an embodiment of the present disclosure.

FIG. 4F illustrates the calendaring of the composite cathode according to an embodiment of the present disclosure.

FIG. 4G is a perspective view illustrating the solution casting of a polymer electrolyte separator using the polymer electrolyte according to an embodiment of the present disclosure.

FIG. 4H is a side view illustrating the doctor blading of the solution cast polymer electrolyte separator according to an embodiment of the present disclosure.

FIG. 5A illustrates a rechargeable battery cell according to an embodiment of the present disclosure.

FIG. 5B illustrates an example of a cross-sectional structure of the rechargeable battery cell according to an embodiment of the present disclosure.

FIG. 5C illustrates an example of a perspective view of the rechargeable battery cell according to an embodiment of the present disclosure.

FIG. 6 is a chart showing linear sweep voltammetry (LSV) measurements of the polymer electrolyte according to an embodiment of the present disclosure.

FIG. 7 is a chart showing linear sweep voltammetry (LSV) measurements of the polymer electrolyte according to an embodiment of the present disclosure.

FIG. 8 is a chart showing the specific capacity of a rechargeable coin cell with a LFP composite cathode according to an embodiment of the present disclosure measured over charge and discharge cycles.

FIG. 9 is a chart showing the specific capacity of a rechargeable coin cell with a LFP composite cathode constructed using the dry placement method according to another embodiment of the present disclosure measured over charge and discharge cycles.

FIG. 10 is a chart showing the specific capacity of a rechargeable pouch cell with a LFP composite cathode according to still another embodiment of the present disclosure measured over charge and discharge cycles.

FIG. 11 is a chart showing the specific capacity of two rechargeable coin cells with a NMC811 composite cathode according to still another embodiment of the present disclosure measured over charge and discharge cycles.

FIG. 12 is a chart showing the specific capacity of a rechargeable coin cell with a LMNO composite cathode according to still another embodiment of the present disclosure measured over charge and discharge cycles.

Like reference numerals are used to describe like parts in all figures of the drawings.

### DETAILED DESCRIPTION

The present disclosure is presented to enable one of ordinary skill in the art to make and use the inventions set forth herein and to incorporate these inventions in the context of particular applications. Various modifications, as well as a variety of uses in different applications will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

### Definitions

As used herein, “PEO” means polyethylene oxide.

As used herein, “PAN” means polyacrylonitrile.

As used herein, “PVP” means polyvinyl pyrrolidone.

As used herein, “CRV” means cyanoethyl polyvinyl alcohol.

A used herein, “NMP” means n-methyl-2-pyrrolidone.

As used herein, “LiDFOB” means lithium difluoro(oxalato)borate.

As used herein, “LiBOB” means lithium bis(oxalato)borate.

As used herein, “LiBF₄” means lithium tetrafluoroborate.

As used herein, “SN” means succinonitrile.

As used herein, “FEC” means fluroethylene carbonate.

As used herein, “IPN” means isophthalonitrile.

As used herein, “BTB” means 1,4, bis(trimethylsilyl) benzene.

As used herein, “CEE” means 2-cyanoethyl ether.

As used herein, “TPN” means 3,3′-thiodipropionitrile.

As used herein, “BCTMD” means 1,3-bis(cyanopropyl)tetramethyldisiloxane.

As used herein, “BVDS” means boron vinyldimethylsiloxide.

As used herein, “TAD” means tetraacetoxy diboroxane.

As used herein, “MSA” means methyl succinic anhydride.

As used herein, “PSA” means phenyl succinic anhydride.

As used herein, “SA” means succinic anhydride

As used herein, “ESW” means electrochemical stability window.

As used herein, “NMC” means lithium nickel manganese cobalt oxide in general.

As used herein, “NMC811” means lithium nickel manganese cobalt oxide with a relative nickel, manganese, and cobalt content of 80%, 10%, and 10% percentage by weight, respectively, of the cathode active material.

As used herein, “LNMO” means lithium nickel manganese oxide in general.

Polymer electrolytes are viable as catholytes and polymer electrolyte separators in solid state and semi-solid lithium-ion rechargeable batteries. For a polymer electrolyte to be technically and commercially viable, it must demonstrate sufficient ionic conductivity. Cyanoresins as a polymer host when combined with a boron-containing lithium salt and a plasticizer and formed into a polymer electrolyte according to embodiments herein exceed the threshold ionic conductivity in a wide temperature range, including at 25° C. Furthermore, the polymer electrolyte of the present disclosure can easily be manufactured into a free-standing membrane, further enhancing its technical and commercial viability as a separator between a cathode and an anode. As a free-standing membrane, the polymer electrolytes of the present disclosure can be manufactured with relative ease through solution casting and dry placement without the need to apply high pressure to the electrolyte material in the manufacturing process. When manufacturing at scale, polymer electrolytes that can form free-standing membranes have significant advantages in roll-to-roll automated manufacturing processes. The quantitative composition of the polymer electrolyte to deliver the required ionic conductivity was determined through testing. Different additives and their use to adjust the performance of the polymer electrolyte have also been determined. The composite cathode and separator were assembled into a rechargeable lithium-ion coin cell and pouch cell and their cycle performance were tested and measured.

### Ionic Conductivity

Ionic conductivity is a performance parameter for a polymer electrolyte, describing the movement of ions through a polymer matrix and governs lithium-ion battery performance. Low ionic conductivity levels can lead to poor battery performance. Low ionic conductivity levels indicate a high degree of crystallinity within the polymer electrolyte. Ionic conductivity values>1×10⁻³ S/cm are highly desirable and are highly unusual for polymer electrolytes at room temperature. For reference purposes, the conventional carbonate based liquid electrolyte with a standard polypropylene (PP) separator achieves an ionic conductivity of approximately 8×10⁻⁴ S/cm. Dry polymer electrolytes that exhibit an ionic conductivity greater than 10⁻⁴ S/cm at room temperature are highly coveted as crossing this threshold generally implies successful room temperature operation at acceptable C-rates (≥0.1C). But this does not mean that polymer electrolytes exhibiting ionic conductivities lower than 1×10⁻⁴ S/cm are obsolete.

Depending on the polymer electrolyte, the slight application of heat can increase ionic conductivity to levels suitable for successful operation at higher C-rates. For example, a polymer electrolyte exhibiting an ionic conductivity at 1×10⁻⁵ S/cm at room temperature may exhibit a ionic conductivity greater than 1×10⁻⁴ S/cm at temperatures exceeding 50° C. For applications where a heat source is available or heat is generated as a function of the operation of battery pack and overall device, such as electric vehicles, a polymer electrolyte with lower than 10⁻⁴ S/cm conductivity would still have great commercial interest. Therefore, dry polymer electrolytes must have an ionic conductivity of greater than 1×10⁻⁵ S/cm to be technically and commercially viable for use as an electrolyte in lithium-ion batteries. Working samples of the polymer electrolyte of the present disclosure that met the ionic conductivity of 1×10⁻⁵ S/cm were determined to be technically and commercially viable.

Ionic conductivity in the working examples of the present disclosure described below were tested using electrochemical impedance spectroscopy over a temperature ranging from 25° C. to 80° C. The frequency ranges were from 100 mHz to 1 MHz with an AC amplitude of 10 mV. Ionic conductivity (o) was calculated using the following equation:

### Equation (1):

$$σ = \frac{t}{A \times R}$$

In equation (1), t is the thickness of the polymer electrolyte, A is the area of the stainless steel electrode, and R is the bulk resistance (determined through EIS). The dielectric constant of a polymer plays an important role in the overall performance of the electrolyte such as ionic conductivity. A material's dielectric constant is the measure of the materials' ability to store electrical energy in an electric field. Certain components with high dielectric constants contribute significantly to increasing the ionic conductivity of a liquid electrolyte. Ethylene carbonate (EC), with a high dielectric constant of 89.78, is used in liquid electrolytes and significantly increases its ionic conductivity. A polymer with a high dielectric constant would similarly increase the ionic conductivity of a polymer electrolyte formulated with that polymer.

This relationship between the dielectric constant of a polymer and the ionic conductivity of the polymer electrolyte formulated with that polymer is further supported by the low dielectric constant of polymers used in conventional polymer electrolytes. Polymers used in conventional polymer electrolytes include polyethylene oxide (PEO), polyacrylonitrile (PAN), and polyvinyl pyrrolidone (PVP). PEO, PAN, and PVP all have low dielectric constants of less than 5.

A technically and commercially viable polymer electrolyte for rechargeable batteries must not only meet the required ionic conductivity, but it must also form a free-standing membrane. A free-standing membrane has the mechanical properties required to function as a composite cathode or a separator in a solid-state battery cell. A free-standing membrane is not gel like. It is also not viscous and it is non-flowable. It is pliable when a normalized force and pressure is applied but retains its x-y dimension. As a free-standing membrane, it also stands in a form that does not require another substrate to provide sufficient structural support.

A free-standing membrane can be formed into large film-like sheets that can be manufactured at scale in automated equipment and processed into rolls. This brings significant advantages for manufacturing complete lithium-ion batteries in a roll-to-roll process. Free-standing membranes manufacturable into large film-like sheets can also be easily cut down to the appropriate size and/or shape for integration into a rechargeable lithium-ion cell.

A free-standing membrane can also be integrated into a rechargeable battery cell with other components such as the cathode and anode without the application of additional pressure or other methods to adhere the membrane to a substrate. A polymer electrolyte separator that is a free-standing membrane can be integrated with a cathode layer through dry placement even though it can also be integrated through solution casting.

Amorphous cyanoethylated polymers, known as cyanoresins, such as cyanoethyl polyvinyl alcohol (CRV), when used as a polymer host for a polymer electrolyte, increases ionic conductivity, and may be used as the polymer host for a polymer electrolyte for use in rechargeable batteries according to the various embodiments of the present disclosure. CRV is a rubbery solid with a relatively low glass transition temperature (Tg) of 30° C. CRV has a dielectric constant of 15 at room temperature, which increases ion dissociation and hence increases ionic conductivity. Furthermore, CRV exhibits good solubility in various organic solvents and can readily be formed into free-standing membranes.

Cyanoethylated polymers (which includes cyanoresins) that are solids at room temperature include cyanoethyl polyvinyl alcohol (CRV), cyanoethyl pullulan (CRS), cyanoethyl sucrose (CRU), and a mixture of CRV and CRS (CRM). The following cyanoresins have a high dielectric constant as shown below:

TABLE 1
Cyanoresin Types

| Cyanoresin Type | CR-S | CR-M | CR-V |
|---|---|---|---|
| Dielectric constant | 18 | 17 | 15 |

A lithium salt is added to the CRV to formulate the polymer electrolyte according to embodiments herein. Different lithium salts can be combined with the CRV to achieve the desired ionic conductivity for the polymer electrolyte. Boron-containing lithium salts can increase ionic conductivity. Boron-containing lithium salts can also be used to produced mechanically stable membranes. Preferred examples of boron-containing lithium salts include lithium difluoro(oxalato)borate (“LiDFOB”), lithium bis(oxalato)borate (“LiBOB”), and lithium tetrafluoroborate (“LiBF₄”).

A plasticizer such as succinonitrile (“SN”) is also an ingredient in the polymer electrolyte of the present disclosure. SN is a solid plastic crystal material that exhibits a melting point of 60° C. The dielectric constant of a material (i.e., the material's ability to store electrical energy in an electric field) plays an important role in the overall performance of an electrolyte containing the material. SN's high dielectric constant enhances the overall ionic conductivity of the polymer electrolyte. In addition, SN exhibits other key advantages such as good solubility with numerous lithium salts and organic solvents, high boiling point (267° C.), and low flammability. SN also improves the transport number of the polymer electrolyte as it is capable of interfering with the crystallization process of the polymer chains. SN's low melting point also reduces the interfacial impedance between the electrode and electrolyte in the solid-state battery.

The individual characteristics of cyanoresins, such as CRV, boron-containing lithium salts, and plasticizers, such as succinonitrile, contribute to ionic conductivity and other important characteristics required for a technically and commercially viable polymer electrolyte. But the mere combination of CRV, LiDFOB or LiBOB, and SN do not automatically form a polymer electrolyte having the threshold ionic conductivity of 1×10⁻⁵ S/cm or higher. Rather, due to interactions that promote competing characteristics, quantities of each component are adjusted to achieve both the threshold ionic conductivity of 1×10⁻⁵ S/cm or higher and the formation of a free-standing membrane.

The polymer host provides the basic mechanical structure for the polymer electrolyte. An increased amount of polymer host provides more structure, leading to generally greater mechanical rigidity. A plasticizer, such as SN, also affects mechanical rigidity although not to the extent of the polymer host.

A boron-containing lithium salt enhances the ionic conductivity of a polymer electrolyte. It does so by increasing the number of charge carriers (lithium cations). But it also simultaneously reduces the semi-crystalline network of the polymer electrolyte to a more amorphous one. As the crystalline network becomes more amorphous, its mechanical rigidity declines. In other words, it becomes softer. Mechanical rigidity has a positive correlation with glass transition temperature. Increasing boron-containing lithium salt content reduces the glass transition temperature of a polymer electrolyte, thus decreasing its mechanical rigidity.

The addition of a plasticizer SN further increases the overall ionic conductivity of the polymer electrolyte. It also reduces the crystallinity of the polymer electrolyte while increasing its overall dielectric constant. But excessive amounts of SN also reduces the crystallization of the crystal network in a polymer electrolyte by reducing the interaction between the lithium cations and the nitrile group of the CRV. But a SN does not have the same impact on crystallization as the boron-containing lithium-salt; the boron-containing lithium-salt disrupts the crystalline structure to a higher degree due to the bulky anion group with a highly delocalized charge. Because of this, the mechanical rigidity of a polymer electrolyte is more sensitive to changes in the lithium-salt than SN formulation changes.

Therefore, an amount of lithium salt in the polymer electrolyte that generates the number of charge carriers that contribute to meeting the threshold ionic conductivity of 1× 10⁻⁵ S/cm while retaining sufficient mechanical rigidity for a free-standing membrane is determined first. This is because it is understood that the lithium salt will fall within the smallest window of variance. Subsequently, an upper bound and a lower bound of the amount of the polymer host is determined. This is because the polymer host has the greater impact on mechanical rigidity and has a smaller window of variance compared to the plasticizer SN. Necessarily, when the amount of the lithium salt is held relatively constant due to its small window of variance, as the amount of polymer host is varied, the amount of plasticizer also varies in an inverse manner. As the amount of polymer host is increased, the amount of the plasticizer is decreased, which increases the mechanical rigidity of the polymer electrolyte. Conversely, as the amount of the polymer host is decreased, the amount of the plasticizer increases, which decreases the mechanical rigidity of the polymer electrolyte. Thus, after fixing the lithium salt concentration within a small window of variance, we determine the lower bound of the polymer host where the amount of plasticizer is not excessive to the point where the polymer electrolyte fails to form a free-standing membrane.

Other additives to the polymer electrolyte can be combined to enhance one or more properties. The additive and the property it enhances when combined with the polymer electrolyte are listed in Table 1.

TABLE 2
Additives

| Additive Name | Abbreviation | Role |
|---|---|---|
| Fluroethylene Carbonate | FEC | Improve Li-metal stability |
| Isophthalonitrile | IPN | Improve mechanical strength, |
| | | increase voltage window |
| 1,4, Bis(trimethylsilyl)benzene | BTB | Increase voltage window |
| 2-Cyanoethyl Ether | CEE | Reduce Tg |
| 3,3′-Thiodipropionitrile | TPN | Reduce Tg |
| 1,3- | BCTMD | Reduce Tg, increase voltage |
| Bis(cyanopropyl)tetramethyldisiloxane | | window |
| Boron Vinyldimethylsiloxide | BVDS | Improve NMC811 cathode |
| Tetraacetoxy Diboroxane | TAD | stability |
| Methyl Succinic Anhydride | MSA | Improve LNMO cathode stability |
| Phenyl Succinic Anhydride | PSA | |
| Succinic Anhydride | SA | |

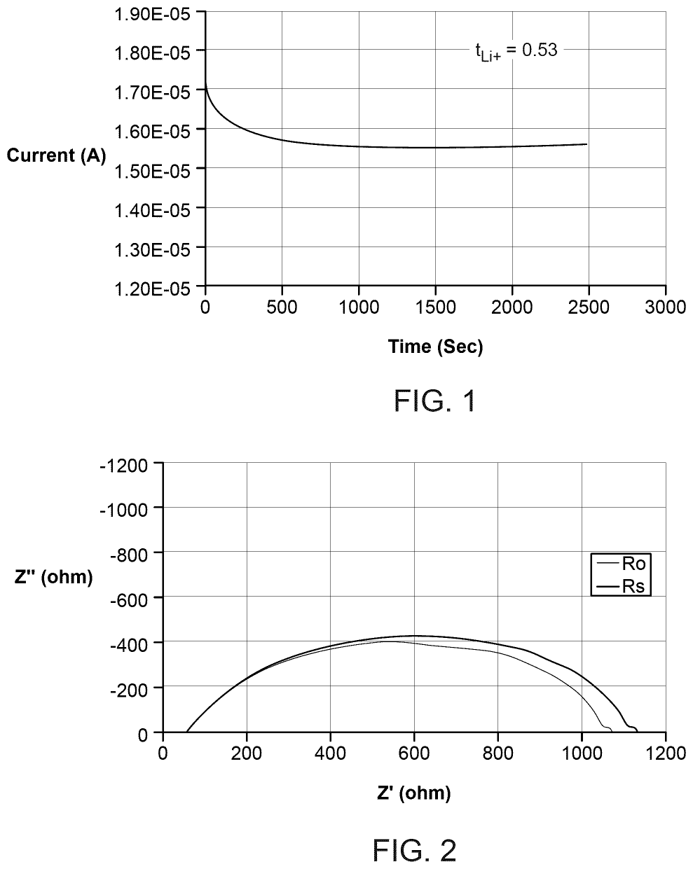

FIGS. 1 and 2 are charts showing measurements used to calculate the transference number of the polymer electrolyte based on the Bruce-Vincent-Evans equation. The transference number (sometimes addressed as the transport number or cationic transference number) is the ratio of the electric current derived from the lithium cation to the total electric current. The transference number is dimensionless and ranges from zero to one. Ideally, a high transference number is desirable as a large value can reduce concentration polarization of electrolytes during charge/discharge cycles, leading to higher power density. Carbonate based liquid electrolytes and PEO-based polymer electrolytes have transference numbers below 0.3. The lithium-ion transference number (t₊) is calculated by applying the Bruce-Vincent-Evans equation.

$${t}_{+} = \frac{{I}_{ss}}{{I}_{o}} \times \frac{( V - {I}_{o} {R}_{o} )}{( V - {I}_{ss} {R}_{ss} )} \qquad Equation 2$$

In equation 2, V is the applied polarization voltage, Iₒ and Iₛₛ is the initial and steady state currents, and Rₒ and Rₛₛ are the initial and steady state interfacial resistance, respectively.

The polymer electrolyte of the present disclosure has a calculated transference number greater than 0.5, indicating that most of the cations that are mobile are Li⁺ ions. The increase in the transference number of the polymer electrolyte of the present disclosure over carbonate based liquid electrolytes and PEO-based polymer electrolytes is attributed to the presence of SN. The polar ends of SN, which contain the nitrile functional group, coordinates with the lithium cation for ion transport, thus providing fast conduction pathways.

The electrochemical stability window (ESW) is another important parameter that determines whether polymer electrolytes can be practically used for lithium-ion batteries. The charge and discharge characteristics of electrode materials are within a specific voltage range, and the polymer electrolyte needs to be able to stable within this voltage range. If not, the polymer electrolyte will be subject to side reactions and thus not capable of maintain normal battery operation. The maximum voltage of cathode materials such as lithium iron phosphate (LFP) and NMC811 is less than 4.3V. However, battery chemistries consisting of a Li-metal anode exhibit higher charge windows and will likely increase to greater than 4.5V. Therefore, a polymer electrolyte that can operate from 0 to 5V vs. Li/Li+ would be ideal. Early polymer electrolytes based on PEO are not capable of exceeding 4V, thus limiting the cathode options to LFP. To achieve a higher ESW, one or more additives are blended with the polymer electrolyte, with the organosilicon based materials providing sufficient windows. Such materials can increase the voltage threshold from 4.7V to 5.5V. A silicon-based BCTMD is added to expand the ESW. With the voltage threshold expanded to 5.5V, a wider selection of cathode materials, including cathode active materials such as LNMO can be used. An ESW stable up to 4.7V may be acceptable for LFP and NMC cathodes. But for higher potential based materials, such as LNMO, at least stability up to 5V is required.

A linear sweep voltammetry (LSV) measurement of a polymer electrolyte is used to determine its ESW. The ESW is determined by observing the flat areas between both major peaks of a linear sweep voltammetry (LSV) measurement.

### Preparation of Polymer Electrolyte Solution and Composite Cathode

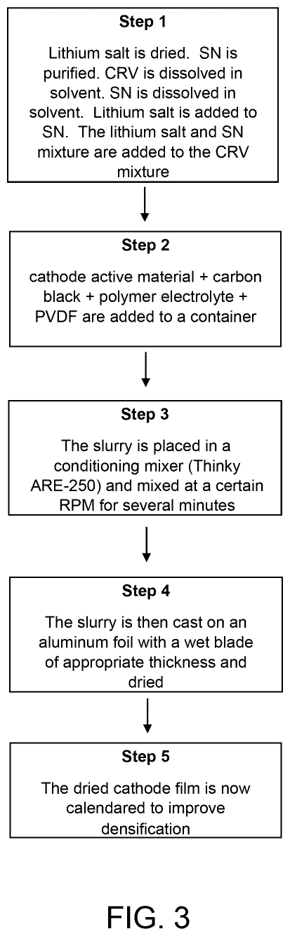

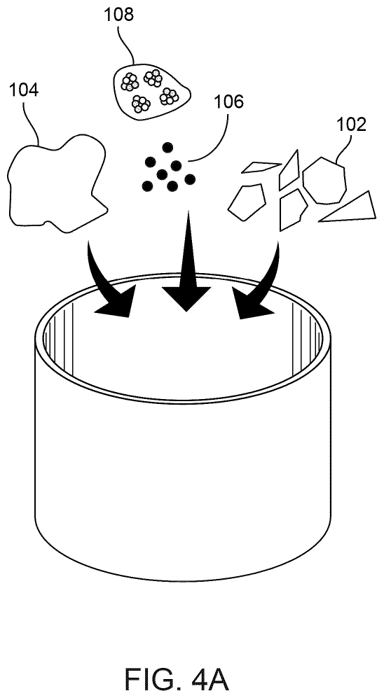

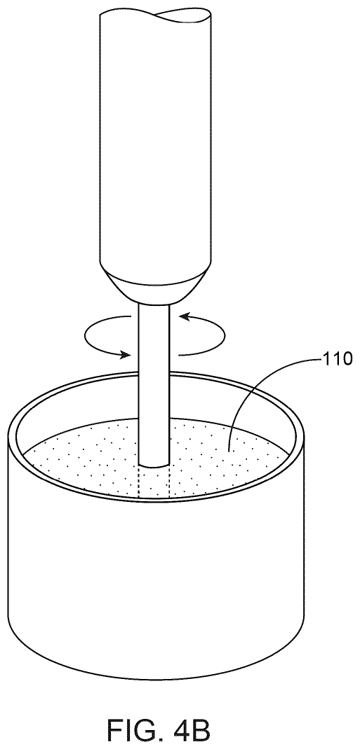

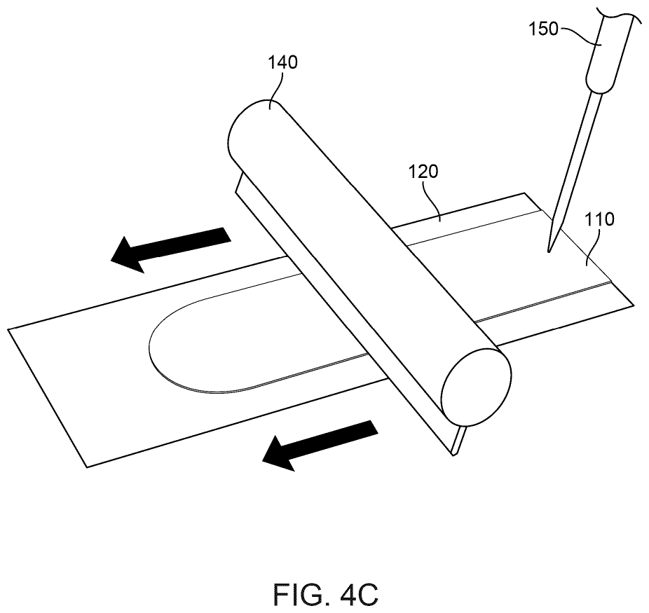

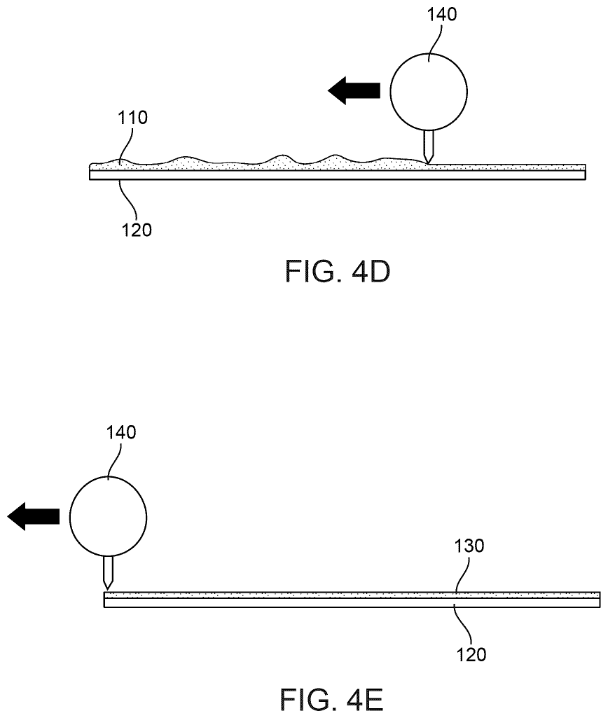

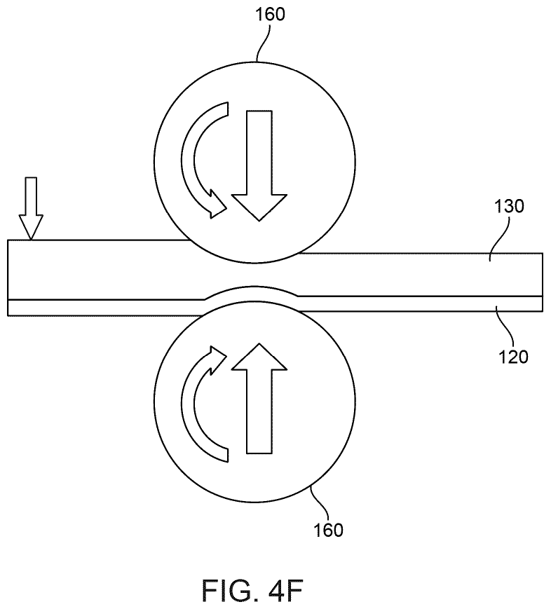

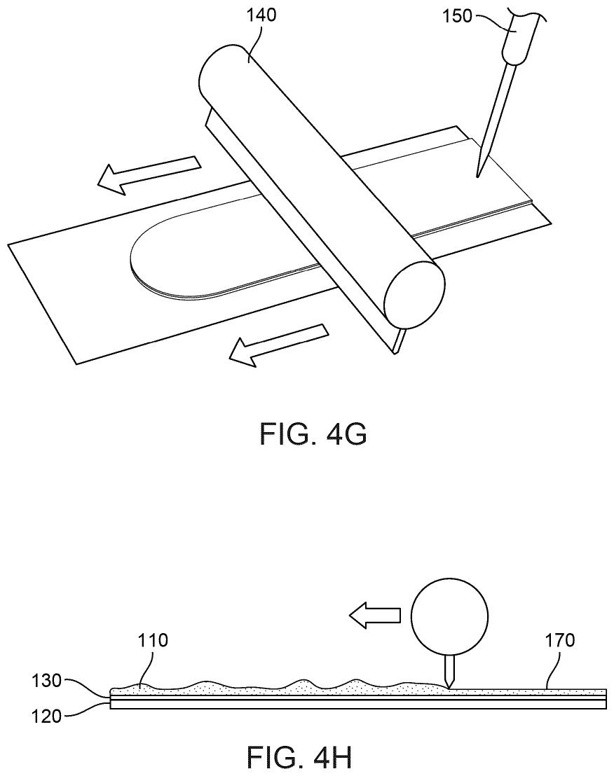

Next, an example of preparing a polymer electrolyte and a composite cathode according to an embodiment of the present disclosure will be described in relation to FIGS. 3 and 4A-4F.

FIG. 3 is a flow chart illustrating the steps of preparing a polymer electrolyte and preparing a composite cathode based on the polymer electrolyte according to an embodiment of the present disclosure. In Step 1, the polymer electrolyte mixture is prepared. In Step 2, the polymer electrolyte is mixed with a cathode active material and other components to form a slurry. In Step 3, the slurry is mixed. In Step 4, the slurry is solution cast onto a current collector to form a composite cathode film. In Step 5, the solution casted composite cathode film is calendared. Each step of FIG. 3 is further detailed below.

FIG. 4A is a perspective view illustrating the preparation of a polymer electrolyte. This corresponds to Step 1 of FIG. 3. In a first container (not shown), a polymer host 102, such as a cyanoethyl polyvinyl alcohol (CRV) is dissolved in an organic solvent 108, such as acetonitrile, N-methyl-2-pyrrolidone (NMP), or cyclohexanone. The CRV mixture is heated and agitated to promote the dissolution of the CRV in the organic solvent. A lithium salt 104, such as a lithium difluoro (oxalate) borate (LiDFOB), is dried in a vacuum oven at a temperature of 80° C. to 120° C. for approximately 8 hours to remove moisture (not shown) to form a dried lithium salt. A plasticizer 106, such as succinonitrile (SN), is distilled to remove any contaminants (not shown). In a second container (not shown), the plasticizer is also dissolved in the organic solvent to form a plasticizer mixture. The plasticizer mixture is also heated and agitated. The dried lithium salt 104 is added to the plasticizer mixture, until a homogenous mixture is obtained. The homogenous mixture is then mixed with the CRV mixture to obtain a mixture of CRV, LiDFOB, and SN. The CRV, LiDFOB, and SN mixture is then mixed under heat until all components are homogenously distributed.

FIG. 4B is a perspective view illustrating the preparation of a slurry mixture for forming a polymer electrolyte composite cathode 100. FIG. 4B corresponds to Step 2 and Step 3 of FIG. 3. A cathode active material, carbon black, polyvinylidene fluoride (PVDF) binder, and the polymer electrolyte mixture are mixed in a container (not shown) to form a slurry 110. 70% cathode active material, 10 wt % carbon black, 15 wt % polymer electrolyte, and 5 wt % PVDF can be used in the slurry mixture. The slurry is transferred to a conditioning mixer (e.g., a Thinky ARE-250) and mixed at certain revolutions per minute (RPM) for several minutes until the mixture is homogenous. The polymer electrolyte function as a catholyte in the composite cathode.

FIG. 4C is a perspective view illustrating the solution casting and doctor blading of a slurry mixture to form the composite cathode. This corresponds to Step 4 of FIG. 3. The slurry 110 is cast onto a current collector 120 that is 16 μm thick with an applicator 150. Suitable current collectors include aluminum current collectors, although copper based current collectors such as copper foils can be used. The organic solvent, in this example NMP, is evaporated until a dense, dry, and black film remains. Although the organic solvent can be removed by evaporation, removal of a solvent is not limited to evaporation. Other next-generation cathode manufacturing methods may be employed, such as extrusion. A doctor blade 140 is then applied to the cast slurry mixture to flatten the slurry mixture 110 onto the current collector 120, resulting in a composite cathode film 130 (FIG. 4E). The doctor blade 140 should be a wet blade of appropriate thickness. FIG. 4D is a side view illustrating the solution casting and doctor blading of the slurry mixture 110 to form the composite cathode film 130 (FIG. 4E). The doctor blade 140 moves across the solution cast slurry mixture 110 to flatten the slurry mixture. FIG. 4E is a side view illustrating the slurry mixture 110 on the current collector 120 after doctor blading to form the cathode film 130. The composite cathode film is then heated to 60° C. to remove any remaining solvent in the slurry mixture.

FIG. 4F illustrates the calendaring of the composite cathode film. This corresponds to Step 5 of FIG. 3. The composite cathode film 130 and current collector 120 are fed through a set of rollers 160. The rollers 160 together rotate in their respective directions as indicated by the arrows to draw in the composite cathode film 130 and current collector 120 and apply a compressing force to calendar the cathode film 130 and current collector 120. The cathode film 130 is calendared to increase its density to 1.7 g/cm³.

### Preparation of Polymer Electrolyte Separator

Next, an example of a polymer electrolyte separator formed using the polymer electrolyte of the present disclosure will be described in relation to FIGS. 4G and 4H.

FIG. 4G is a perspective view illustrating the solution casting of a polymer electrolyte separator using the polymer electrolyte, according to an embodiment of the present disclosure. The polymer electrolyte mixture 110 is solution cast onto the composite cathode 100 by means of an applicator 150. One example of an applicator is a dropper, but any device by which a small amount of the mixture 110 can be applied to the composite cathode 100 and then dispersed can be used. FIG. 4H is a side view illustrating the doctor blading of the solution cast polymer electrolyte separator, according to an embodiment of the present disclosure. Once the mixture 110 is cast onto the formed composite cathode 100, a doctor blade 140 is used to spread the mixture 110 to form an even layer over the entire surface of the composite cathode 100. The organic solvent in the mixture 110 is allowed to evaporate, forming a polymer electrolyte layer 170. When formed in this manner, the polymer electrolyte layer fuses with the composite cathode film 130 and does not misalign or detach.

The solution cast method for casting a polymer electrolyte as a separator according to the embodiment of the present disclosure described herein has several benefits. First, as between an electrode and the polymer electrolyte, the electrode-electrolyte interfacial impedance is very low. This is because the polymer electrolyte is in direct contact with the electrode. This is regardless of whether the electrode that the polymer electrolyte is solution cast onto is a cathode or an anode. Polymer electrolytes that are directly cast onto the cathode can exhibit better electrochemical performance at higher C-rates. Second, it is a scalable and cost effective method to integrate polymer electrolyte films into solid-state batteries. However, the polymer electrolyte separator of the present disclosure can also be cast onto a separate substrate, peeled off, and then dry placed onto the composite cathode.

Solution casting the polymer electrolyte as a separator is not limited to forming a single polymer electrolyte layer. The solution casting method can be repeated multiple times to form a separator comprising multiple polymer electrolyte separator layers. Depending on the overall cell design, multiple polymer electrolyte layers can be formed to create a separator of 100 μm or greater to improve performance of separator function to protect against penetration of the separator by dendrites.

The polymer electrolyte present in the composite cathode functioning as a catholyte and the polymer electrolyte separator have the same ionic conductivity. Although the polymer electrolyte separator is formulated with the same polymer electrolyte embodiment as used in the composite cathode, the polymer electrolyte separator is not limited to the same embodiment and can be formulated with a polymer electrolyte of a different embodiment in the present disclosure.

### Lithium-Ion Rechargeable Cell

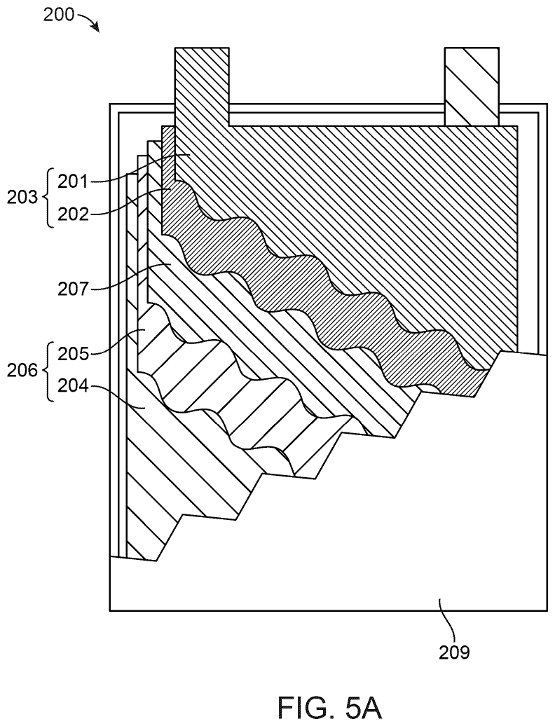

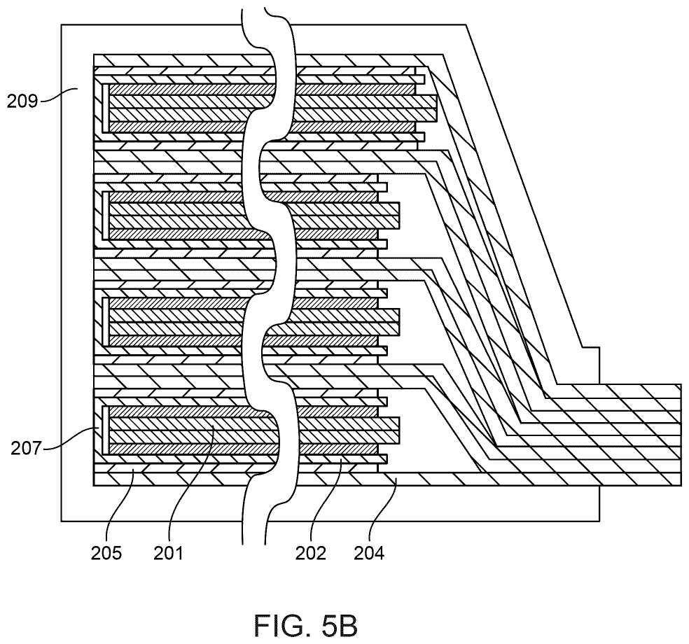

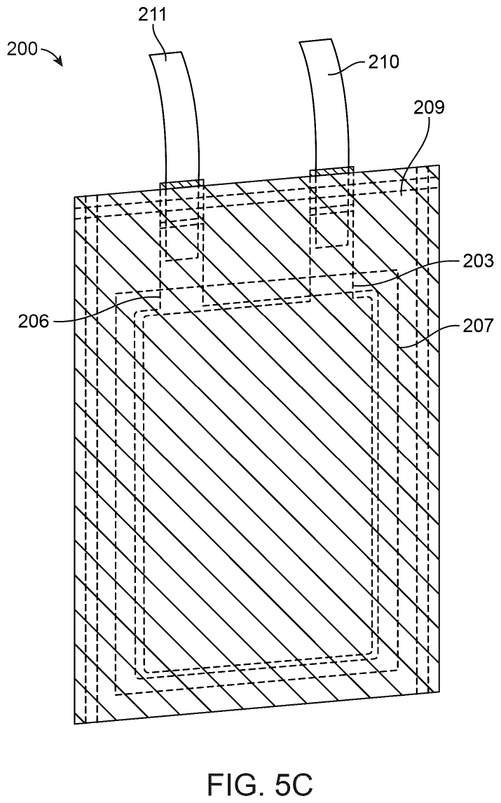

Next, an example of a rechargeable battery cell using the composite cathode, and the polymer electrolyte separator according to embodiment of the present disclosure will be described in relation to FIGS. 5A-5C.

FIG. 5A illustrates a rechargeable battery cell 200 according to embodiment of the present disclosure. The cell 200 includes a cathode current collector 201, a composite cathode film 202, an anode current collector 204, and an anode active material layer 205. The composite cathode film 202 and the cathode current collector 201 together form the composite cathode 203. The anode active material layer 205 and the anode current collector 204 together form the anode 206. A polymer electrolyte separator 207 separates the composite cathode 203 and the anode 206. In one example, the composite cathode 203 is cut to 50 mm×34 mm in size and the anode 206 is cut to 49 mm×33 mm in size. The composite cathode 203 is intentionally cut so that it is larger than the anode 206 to prevent an internal short circuit due to contact of the cathode with the anode. As shown in FIG. 5C, a nickel tab 210 is welded onto the composite cathode 203 and a nickel tab 211 is also welded onto the anode 206. The weld and internal/external tab portions can be covered with Kapton tape (not shown) to prevent a short-circuit.

In FIG. 5A, cathode current collector 201 and the anode current collector 204 also serve as terminals for electrical contact with an external portion. For this reason, the cathode current collector 201 and the anode current collector 204 may be arranged so as to be partly exposed to the outside of the exterior body 209. Alternatively, the cathode current collector 201 or the anode current collector 204 may be bonded to each other by ultrasonic welding, and instead of the positive electrode current collector 201 and the negative electrode current collector 204, the lead electrode may be exposed to the outside of the exterior body 209.

In some embodiments, non-conductive inserts (not shown in FIGS. 5A and 5B) are added at each end of the stack of the rechargeable battery cell. The non-conductive inserts add mechanical rigidity to the stack. A polyolefin film (not shown) can also be tightly wrapped around the stack to ensure that the components of the stack do not shift and remain in interfacial contact with each other.

As the exterior body 209 of the rechargeable battery cell 200, for example, a laminate film having a multi-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 5B illustrates an example of a cross-sectional structure of the rechargeable battery cell 200. Although FIG. 5A illustrates an example including only two current collectors for simplicity, an actual battery includes a plurality of electrode stacks. The example in FIG. 5B includes 16 electrode layers. The rechargeable battery cell 200 has flexibility even though it includes 16 electrode layers. FIG. 5B illustrates a structure including 8 layers of anode current collectors 204 and 8 layers of cathode current collectors 201, i.e., 16 layers in total. Note that FIG. 5B illustrates a cross section of the lead portion of the negative electrode, and the 8 anode current collectors 204 are bonded to each other by ultrasonic welding. But the number of electrode layers is not limited to 16, and may be more than 16 or less than 16. With a large number of electrode layers, the rechargeable battery cell can have a higher capacity. In contrast, with a small number of electrode layers, the rechargeable battery can be thinner and have greater flexibility.

FIG. 5C illustrates an example of a perspective view of the rechargeable battery cell 200.

### Examples 1A-1H (LiDFOB)

In Examples 1A-1H described below, a series of polymer electrolyte compositions were formulated into a polymer electrolyte composite cathode and a polymer electrolyte separator with varying amounts of lithium salt, according to various embodiments of the present disclosure, and were tested.

### Example 1A

In Example 1A, a polymer electrolyte was prepared using the method for preparation of a polymer electrolyte mixture of the present disclosure. In a first container, 32.5 wt % cyanoethyl polyvinyl alcohol (CRV) was dissolved in an organic solvent NMP. The CRV mixture was heated and agitated to promote the dissolution of the CRV in the organic solvent. LiDFOB, was dried in a vacuum oven at a temperature of 80° C. to 120° C. for approximately 8 hours to remove moisture. SN was distilled to remove any contaminants. In a second container, the SN was dissolved in the organic solvent to form a plasticizer mixture. The plasticizer mixture was then heated and agitated. The dried LiDFOB was added to the plasticizer mixture until a homogenous mixture was obtained. The homogenous mixture was then mixed with the CRV mixture to eventually obtain a mixture of 32.5 wt % CRV, 2.5 wt % LiDFOB, and 65.0 wt % SN. The CRV, LiDFOB, and SN mixture was then mixed under heat until all components were homogenously distributed.

A slurry mixture was prepared following the method of preparation of a slurry mixture of the polymer electrolyte composite cathode of the present disclosure. A cathode active material, carbon black, and polyvinylidene fluoride binder, and the polymer electrolyte mixture were mixed to form a slurry mixture 110. The slurry was cast onto an aluminum current collector. The organic solvent NMP was evaporated until a dense, dry, and black film remained. The cast slurry mixture was then flattened onto the current collector using a doctor blade to form a cathode film. The cathode film was then calendared to form a composite cathode.

A polymer electrolyte separator layer was prepared using the method for preparing a solid polymer electrolyte separator with the polymer electrolyte of the present disclosure. The polymer electrolyte mixture was solution cast by means of a dropper. After the polymer electrolyte was solution cast, a film applicator, such as a doctor blade, was used to spread the mixture to form an even layer. The organic solvent in the polymer electrolyte mixture was removed through evaporation over time, eventually solidifying into the polymer electrolyte separator layer.

The ionic conductivity of the polymer electrolyte separator was measured at 25° C., 50° C., and 80° C. The polymer electrolyte separator exhibited ionic conductivity of 0.0491× 10⁻³ S/cm at 25° C., 0.182×10⁻³ S/cm at 50° C., and 1.08×10⁻³ S/cm at 80° C.

### Example 1B

In Example 1B, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 31.25 wt % CRV, 5.0 wt % LiDFOB, and 63.75 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 1B was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.206× 10⁻³ S/cm at 25° C., 0.55×10⁻³ S/cm at 50° C., and 2.04×10⁻³ S/cm at 80° C.

### Example 1C

In Example 1C, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 30.0 wt % CRV, 7.50 wt % LiDFOB, and 62.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 1C was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.490×10⁻³ S/cm at 25° C., 0.831× 10⁻³ S/cm at 50° C., and 3.04×10⁻³ S/cm at 80° C.

### Example 1D

In Example 1D, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 28.75 wt % CRV, 10.0 wt % LiDFOB, and 61.25 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 1D was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.618×10⁻³ S/cm at 25° C., 0.182× 10⁻³ S/cm at 50° C., and 5.60×10⁻³ S/cm at 80° C.

### Example 1E

In Example 1E, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 27.50 wt % CRV, 12.50 wt % LiDFOB, and 60.0 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 1E was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.992× 10⁻³ S/cm at 25° C., 3.11× 10⁻³ S/cm at 50° C., and 6.91× 10⁻³ S/cm at 80° C.

### Example 1F

In Example 1F, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 26.25 wt % CRV, 15.0 wt % LIDFOB, and 58.75 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example IF was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 1.03× 10⁻³ S/cm at 25° C., 3.45× 10⁻³ S/cm at 50° C., and 3.83×10⁻³ S/cm at 80° C.

### Example 1G

In Example 1G, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 25.0 wt % CRV, 17.50 wt % LIDFOB, and 57.50 wt % SN.

An attempt was made to prepare a composite cathode following the method of preparation of a composite cathode of the present disclosure like in Example 1A. An attempt was also made to prepare a polymer electrolyte separator layer using the method for preparing a solid polymer electrolyte separator of the present disclosure like in Example 1A.

The composition could not be formed into a mechanically stable composite cathode or polymer electrolyte separator film. A mechanically stable polymer electrolyte separator must not be tacky and must be capable of being shaped into a substantially solid, free-standing membrane. Ionic conductivity values could not be measured.

### Example 1H

In Example 1H, a polymer electrolyte mixture was also prepared using the method for preparation of a polymer electrolyte mixture of the present disclosure like in Example 1A. CRV was used as the polymer host, LiDFOB was used as the lithium salt, and SN was used as the plasticizer. The polymer electrolyte mixture was comprised of 23.75 wt % CRV, 20.0 wt % LiDFOB, and 56.25 wt % SN.

An attempt was made to prepare a composite cathode following the method of preparation of a composite cathode of the present disclosure like in Example 1A. An attempt was also made to prepare a polymer electrolyte separator layer using the method for preparing a solid polymer electrolyte separator of the present disclosure like in Example 1A.

The composition could not be formed into a mechanically stable polymer electrolyte separator film. A mechanically stable polymer electrolyte separator must not be tacky and must be capable of being shaped into a substantially solid, free-standing membrane. Ionic conductivity values could not be measured.

TABLE 3
Summary of Working Examples 1A-1H

| Working | Polymer Host | Lithium Salt | Plasticizer | Ionic Conductivity (S/cm) | | |
|---|---|---|---|---|---|---|
| Example | CR-V (wt %) | LiDFOB (wt %) | SN (wt %) | 25° C. | 50° C. | 80° C. |
| 1A | 32.50 | 2.50 | 65.00 | 0.0491 × 10⁻³ | 0.182 × 10⁻³ | 1.080 × 10⁻³ |
| 1B | 31.25 | 5.00 | 63.75 | 0.206 × 10⁻³ | 0.55 × 10⁻³ | 2.040 × 10⁻³ |
| 1C | 30.00 | 7.50 | 62.50 | 0.490 × 10⁻³ | 0.831 × 10⁻³ | 3.040 × 10⁻³ |
| 1D | 28.75 | 10.00 | 61.25 | 0.618 × 10⁻³ | 0.182 × 10⁻³ | 5.600 × 10⁻³ |
| 1E | 27.50 | 12.50 | 60.00 | 0.992 × 10⁻³ | 3.110 × 10⁻³ | 6.910 × 10⁻³ |
| 1F | 26.25 | 15.00 | 58.75 | 1.030 × 10⁻³ | 3.450 × 10⁻³ | 3.830 × 10⁻³ |

| | | | | |
|---|---|---|---|---|
| 1G | 25.00 | 17.50 | 57.50 | Could not be measured |
| 1H | 23.75 | 20.00 | 56.25 | Could not be measured |

Through Examples 1A and 1B, it was determined that at least a LiDFOB content of 2.5 wt % was necessary to meet the threshold ionic conductivity of 1.03×10⁻⁵ S/cm at 25° C. and greater. Between Example 1B and Example 1A where LiDFOB was decreased from 5 wt % to 2.5 wt %, the decrease in ionic conductivity was by an order of magnitude from the 1×10⁻⁴ S/cm to 1×10⁻⁵ S/cm. A further decrease below 2.5 wt % LiDFOB would drop the ionic conductivity below 1×10⁻⁵ S/cm. Therefore, the polymer electrolyte of the present disclosure is at least 2.5 wt % LiDFOB.

In subsequent Examples 1B through 1H, an upper bound of the amount of LiDFOB was determined. In each Example 1B through 1H, the amount of the LiDFOB was gradually increased by 2.5 wt %. The increase in LiDFOB reduces the semi-crystalline network of the polymer electrolyte. Finally, in Example 1G, when the LiDFOB was increased to 17.50 wt %, a free-standing membrane could not be formed. Thus, it was determined that the polymer electrolyte of the present embodiment should not comprise more than 15 wt % LiDFOB.

### Examples 2A-2J (LiDFOB)

In Examples 2A-2J described below, a series of polymer electrolyte compositions were formulated into a polymer electrolyte separator with varying amounts of polymer host, according to various embodiments of the present disclosure, and tested.

### Example 2A

In Example 2A, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 35.0 wt % CRV, 7.5 wt % LiDFOB, and preferably of 57.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2A was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.0852× 10⁻³ S/cm at 25° C., 0.235×10⁻³ S/cm at 50° C., and 0.744×10⁻³ S/cm at 80° C.

### Example 2B

In Example 2B, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 40.0 wt % CRV, 7.5 wt % LiDFOB, and 52.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2B was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.0817× 10⁻³ S/cm at 25° C., 0.311× 10⁻³ S/cm at 50° C., and 0.881× 10⁻³ S/cm at 80° C.

### Example 2C

In Example 2C, a polymer electrolyte mixture was also prepared using the method for preparation of a polymer electrolyte mixture of the present. CRV was used as the polymer host, LiDFOB was used as the lithium salt, and SN was used as the plasticizer. The polymer electrolyte mixture was comprised of 35.0 wt % CRV, 12.5 wt % LiDFOB, and 52.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2C was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.212× 10⁻³ S/cm at 25° C., 0.480× 10⁻³ S/cm at 50° C., and 1.65×10⁻³ S/cm at 80° C.

### Example 2D

In Example 2D, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 35.0 wt % CRV, preferably of 15.0 wt % LiDFOB, and preferably of 50.0 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2D was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.163×10⁻³ S/cm at 25° C., 0.360× 10⁻³ S/cm at 50° C., and 1.26×10⁻³ S/cm at 80° C.

### Example 2E

In Example 2E, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 40.0 wt % CRV, 12.5 wt % LiDFOB, and 47.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2E was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.0679×10⁻³ S/cm at 25° C., 0.181× 10⁻³ S/cm at 50° C., and 0.534×10⁻³ S/cm at 80° C.

### Example 2F

In Example 2F, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 40.0 wt % CRV, 15.0 wt % LiDFOB, and 45.0 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2F was formed into a mechanically stable composite cathode and a mechanically stable polymer electrolyte separator film. The ionic conductivity of the polymer electrolyte separator film was measured at 25° C., 50° C., and 80° C. The polymer electrolyte separator film exhibited ionic conductivity of 0.0622× 10⁻³ S/cm at 25° C., 0.113×10⁻³ S/cm at 50° C., and 0.457×10⁻³ S/cm at 80° C.

### Example 2G

In Example 2G, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 10.0 wt % CRV, 7.5 wt % LiDFOB, and 82.5 wt % SN.

An attempt was made to prepare a composite cathode following the method of preparation of a composite cathode of the present disclosure like in Example 1A. An attempt was also made to prepare a polymer electrolyte separator layer using the method for preparing a solid polymer electrolyte separator of the present disclosure like in Example 1A.

The composition could not be formed into a mechanically stable composite cathode or separator film membrane. A mechanically stable film must not be tacky and must be capable of being shaped into a free-standing membrane. Ionic conductivity values could not be measured.

### Example 2H

In Example 2H, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 15.0 wt % CRV, 7.5 wt % LiDFOB, and 77.5 wt % SN.

An attempt was made to prepare a composite cathode following the method of preparation of a composite cathode of the present disclosure like in Example 1A. An attempt was also made to prepare a polymer electrolyte separator layer using the method for preparing a solid polymer electrolyte separator of the present disclosure like in Example 1A.

The composition could not be formed into a mechanically stable composite cathode or separator film membrane. A mechanically stable film must not be tacky and must be capable of being shaped into a free-standing membrane. Ionic conductivity values could not be measured.

### Example 2I

In Example 2I, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 20.0 wt % CRV, 7.5 wt % LiDFOB, and 72.5 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2I was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.408×10⁻³ S/cm at 25° C., 1.10× 10⁻³ S/cm at 50° C., and 2.10×10⁻³ S/cm at 80° C.

### Example 2J

In Example 2J, a polymer electrolyte mixture was also prepared using the method for preparation of a polymer electrolyte mixture of the present disclosure. CRV was used as the polymer host, LiDFOB was used as the lithium salt, and SN was used as the plasticizer. The polymer electrolyte mixture was comprised of 22.5 wt % CRV, 7.5 wt % LiDFOB, and 70.0 wt % SN.

A composite cathode was also prepared following the method of preparation of the polymer electrolyte composite cathode of the present disclosure like in Example 1A. A polymer electrolyte separator layer was also prepared using the method for preparing a solid polymer electrolyte separator of the present disclosure like in Example 1A.

The polymer electrolyte of Example 2J was formed into a mechanically stable composite cathode and a mechanically stable polymer electrolyte separator film. The ionic conductivity of the polymer electrolyte separator film was measured at 25° C., 50° C., and 80° C. The polymer electrolyte separator exhibited ionic conductivity of 0.163×10⁻³ S/cm at 25° C., 0.735× 10⁻³ S/cm at 50° C., and 1.71×10⁻³ S/cm at 80° C.

TABLE 4
Summary of Working Examples 2A-2J

| Working | Polymer Host | Lithium Salt | Plasticizer | Ionic Conductivity (S/cm) | | |
|---|---|---|---|---|---|---|
| Example | CR-V (wt %) | LiDFOB (wt %) | SN (wt %) | 25° C. | 50° C. | 80° C. |
| 2A | 35.00 | 7.50 | 57.50 | 0.0852 × 10⁻³ | 0.2350 × 10⁻³ | 0.7440 × 10⁻³ |
| 2B | 40.00 | 7.50 | 52.50 | 0.0817 × 10⁻³ | 0.3110 × 10⁻³ | 0.8810 × 10⁻³ |
| 2C | 35.00 | 12.50 | 52.50 | 0.2120 × 10⁻³ | 0.4800 × 10⁻³ | 1.6500 × 10⁻³ |
| 2D | 35.00 | 15.00 | 50.00 | 0.1630 × 10⁻³ | 0.3600 × 10⁻³ | 1.2600 × 10⁻³ |
| 2E | 40.00 | 12.50 | 47.50 | 0.0679 × 10⁻³ | 0.1810 × 10⁻³ | 0.5340 × 10⁻³ |
| 2F | 40.00 | 15.00 | 45.00 | 0.0622 × 10⁻³ | 0.1130 × 10⁻³ | 0.4570 × 10⁻³ |
| 2G | 10.00 | 7.50 | 82.50 | Could not be measured | | |
| 2H | 15.00 | 7.50 | 77.50 | Could not be measured | | |
| 2I | 20.00 | 7.50 | 72.50 | 0.4080 × 10⁻³ | 1.1000 × 10⁻³ | 2.1000 × 10⁻³ |
| 2J | 22.50 | 7.50 | 70.00 | 0.1630 × 10⁻³ | 0.7350 × 10⁻³ | 1.7100 × 10⁻³ |

It was determined through Examples 1A-1H that the upper bound of LiDFOB was 15 wt %. As predicted, LiDFOB fell within a small window of variance. Subsequently, an upper and lower bound of CRV was determined while holding LiDFOB at values within its small window of variance.

Example 1F with 26.25 wt % CRV, 15% wt % LiDFOB, and 58.75 wt % SN, which had the upper bound of LiDFOB of 15.00 wt %, had an ionic conductivity of 1.03×10⁻³ S/cm. From there, increasing the amount of CRV to 35 wt % while holding LiDFOB at 15 wt % in Example 2D resulted in the ionic conductivity dropping to 0.163×10⁻³ S/cm at 25° C. Increasing CRV further to 40 wt % while still holding LiDFOB constant at 15% in Example 2F resulted in ionic conductivity dropping further to 0.0622×10⁻³ S/cm at 25° C. Then, holding CRV constant at 40 wt % while decreasing LiDFOB to 12.5 wt % in Example 2E resulted in an insignificant increase in ionic conductivity to 0.0679×10⁻³ S/cm at 25° C. Furthermore, holding CRV constant again at 40 wt % while decreasing LiDFOB to 7.5 wt % in Example 2B again resulted in an insignificant increase in ionic conductivity to 0.0817×10⁻³ S/cm at 25° C. In Example 2A, decreasing the CRV content to 35 wt % but holding LiDFOB content constant at 7.5 wt % resulted in the ionic conductivity increasing slightly to 0.0852×10⁻³ S/cm at 25° C. The series of working examples proved that the upper bound of CRV content should not be greater than 40 wt %, after which ionic conductivity will fall precipitously.

Example 2C and 2D confirmed this. Holding CRV at 35 wt % and then increasing LIDFOB to 12.5 wt % and 15.0 wt % resulted in ionic conductivity measurements one order of magnitude higher at 0.212×10⁻³ S/cm and 0.163×10⁻³ S/cm at 25° C. respectively.

The lower bound of CRV content was tested by decreasing CRV content in Examples 2G-2J. CRV content set at 20.0 wt % and 22.5 wt % in Examples 2I and 2J respectively confirmed that the amount of CRV could be decreased while still maintaining the same order of magnitude of ionic conductivity compared to Examples 2C-2F. But decreasing CRV content to 10 wt % and 15 wt % in Examples 2G and 2H respectively confirmed that any CRV content below 20 wt % is not viable. This is because excessively low CRV levels must be matched by high levels of SN, resulting in membranes that are not free-standing. The lower bound of CRV according to the embodiments of the present disclosure is thus 20.0 wt %.

Finally, according to Example 2F, the lower bound of SN is 45 wt %. And according to Example 2I, the upper bound of SN is 72.5 wt %. Its upper and lower bounds are necessarily dictated by the bounds of LiDFOB and CRV, which have small windows of variance.

### Examples 3A-3H

In Examples 3A-3H described below, a series of polymer electrolyte compositions using LiBOB as the lithium salt were formulated into a polymer electrolyte separator with varying amounts of LiBOB, according to various embodiments of the present disclosure, and were tested.

### Example 3A

In Example 3A, a polymer electrolyte was prepared using the method for preparation of a polymer electrolyte mixture of the present disclosure. In a first container, 32.5 wt % cyanoethyl polyvinyl alcohol (CRV) was dissolved in an organic solvent NMP. The CRV mixture was heated and agitated to promote the dissolution of the CRV in the organic solvent. LiBOB was dried in a vacuum oven at a temperature of 80° C. to 120° C. for approximately 8 hours to remove moisture. SN was distilled to remove any contaminants. In a second container, the SN was dissolved in the organic solvent to form a plasticizer mixture. The plasticizer mixture was then heated and agitated. The dried LiDOB was added to the plasticizer mixture until a homogenous mixture was obtained. The homogenous mixture was then mixed with the CRV mixture to eventually obtain a mixture of 32.5 wt % CRV, 2.5 wt % LiBOB, and 65 wt % SN. The CRV, LiBOB, and SN mixture was then mixed under heat until all components were homogenously distributed.

A slurry was prepared following the method of preparation of a slurry mixture of the polymer electrolyte composite cathode of the present disclosure. A cathode active material, carbon black, and polyvinylidene fluoride binder, and the polymer electrolyte mixture were mixed to form a slurry. The slurry was cast onto an aluminum current collector. The organic solvent NMP was evaporated until a dense, dry, and black film remained. The cast slurry mixture was then flattened onto the aluminum current collector using a doctor blade to form a cathode film. The cathode film was then calendared to form a composite cathode.

A polymer electrolyte separator layer was prepared using the method for preparing a solid polymer electrolyte separator with the polymer electrolyte of the present disclosure. The polymer electrolyte mixture was solution cast by means of a dropper. After the polymer electrolyte was solution cast, a film applicator was used to spread the mixture to form an even layer. The organic solvent in the polymer electrolyte mixture was allowed to evaporate over time, eventually solidifying into the polymer electrolyte separator layer.

The ionic conductivity of the polymer electrolyte separator was measured at 25° C., 50° C., and 80° C. The polymer electrolyte separator film exhibited ionic conductivity of 0.0128× 10⁻³ S/cm at 25° C., 0.141×10⁻³ S/cm at 50° C., and 0.469×10⁻³ S/cm at 80° C.

### Example 3B

In Example 3B, a polymer electrolyte mixture was also prepared using the method for preparation of a polymer electrolyte mixture of the present disclosure. CRV was used as the polymer host, LiBOB was used as the lithium salt, and SN was used as the plasticizer. The polymer electrolyte mixture was comprised of 31.25 wt % CRV, 5.0 wt % LiDFOB, and 63.75 wt % SN.

A composite cathode was also prepared following the method of preparation of the polymer electrolyte composite cathode of the present disclosure like in Example 3A. A polymer electrolyte separator layer was also prepared using the method for preparing a solid polymer electrolyte separator of the present disclosure like in Example 3A.

The polymer electrolyte of Example 3B was formed into a mechanically stable composite cathode and a mechanically stable polymer electrolyte separator film. The ionic conductivity of the polymer electrolyte separator film was measured at 25° C., 50° C., and 80° C. The polymer electrolyte separator film exhibited ionic conductivity of 0.0375×10⁻³ S/cm at 25° C., 0.315×10⁻³ S/cm at 50° C., and 0.406×10⁻³ S/cm at 80° C.

### Example 3C

In Example 3C, a polymer electrolyte mixture was also prepared using the method for preparation of a polymer electrolyte mixture of the present disclosure. CRV was used as the polymer host, LiBOB was used as the lithium salt, and SN was used as the plasticizer. The polymer electrolyte mixture was comprised of 30.0 wt % CRV, 7.5 wt % LiBOB, and 62.5 wt % SN.

A composite cathode was also prepared following the method of preparation of the polymer electrolyte composite cathode of the present disclosure like in Example 3A. A polymer electrolyte separator layer was also prepared using the method for preparing a solid polymer electrolyte separator of the present disclosure like in Example 3A.

The polymer electrolyte of Example 3C was formed into a mechanically stable composite cathode and a mechanically stable polymer electrolyte separator film. The ionic conductivity of the polymer electrolyte separator was measured at 25° C., 50° C., and 80° C. The polymer electrolyte separator film exhibited ionic conductivity of 0.0556× 10⁻³ S/cm at 25° C., 0.220×10⁻³ S/cm at 50° C., and 0.521×10⁻³ S/cm at 80° C.

### Example 3D

In Example 3D, a polymer electrolyte mixture was also prepared using the method for preparation of a polymer electrolyte mixture of the present disclosure. CRV was used as the polymer host, LiBOB was used as the lithium salt, and SN was used as the plasticizer. The polymer electrolyte mixture was comprised of 28.75 wt % CRV, 10.0 wt % LiBOB, and 61.25 wt % SN.

A composite cathode was also prepared following the method of preparation of the polymer electrolyte composite cathode of the present disclosure like in Example 3A. A polymer electrolyte separator layer was also prepared using the method for preparing a solid polymer electrolyte separator of the present disclosure like in Example 3A.

The polymer electrolyte of Example 3D was formed into a mechanically stable composite cathode and a mechanically stable polymer electrolyte separator film. The ionic conductivity of the polymer electrolyte separator was measured at 25° C., 50° C., and 80° C. The polymer electrolyte separator film exhibited ionic conductivity of 0.0720×10⁻³ S/cm at 25° C., 0.386× 10⁻³ S/cm at 50° C., and 0.565×10⁻³ S/cm at 80° C.

### Example 3E

In Example 3E, a polymer electrolyte mixture was also prepared using the method for preparation of a polymer electrolyte mixture of the present disclosure. CRV was used as the polymer host, LiBOB was used as the lithium salt, and SN was used as the plasticizer. The polymer electrolyte mixture was comprised of 27.5 wt % CRV, 12.5 wt % LiBOB, and 60.0 wt % SN.

A composite cathode was also prepared following the method of preparation of the polymer electrolyte composite cathode of the present disclosure like in Example 3A. A polymer electrolyte separator layer was also prepared using the method for preparing a solid polymer electrolyte separator of the present disclosure like in Example 3A.

The polymer electrolyte of Example 3E was formed into a mechanically stable composite cathode and a mechanically stable polymer electrolyte separator film. The ionic conductivity of the polymer electrolyte separator was measured at 25° C., 50° C., and 80° C. The polymer electrolyte separator film exhibited ionic conductivity of 0.198×10⁻³ S/cm at 25° C., 0.366× 10⁻³ S/cm at 50° C., and 0.523×10⁻³ S/cm at 80° C.

### Example 3F

In Example 3F, a polymer electrolyte mixture was also prepared using the method for preparation of a polymer electrolyte mixture of the present disclosure. CRV was used as the polymer host, LiBOB was used as the lithium salt, and SN was used as the plasticizer. The polymer electrolyte mixture was comprised of 26.25 wt % CRV, 15.0 wt % LiDFOB, and 58.75 wt % SN.

A composite cathode was also prepared following the method of preparation of the polymer electrolyte composite cathode of the present disclosure like in Example 3A. A polymer electrolyte separator layer was also prepared using the method for preparing a solid polymer electrolyte separator of the present disclosure like in Example 3A.

The polymer electrolyte of Example 3F was formed into a mechanically stable composite cathode and a mechanically stable polymer electrolyte separator film. The ionic conductivity of the polymer electrolyte separator was measured at 25° C., 50° C., and 80° C. The polymer electrolyte separator film exhibited ionic conductivity of 0.196×10⁻³ S/cm at 25° C., 0.634× 10⁻³ S/cm at 50° C., and 1.360×10⁻³ S/cm at 80° C.

TABLE 5
Summary of Working Examples 3A-3F

| Working | Polymer Host | Lithium Salt | Plasticizer | Ionic Conductivity (S/cm) | | |
|---|---|---|---|---|---|---|
| Example | CR-V (wt %) | LiBOB (wt %) | SN (wt %) | 25° C. | 50° C. | 80° C. |
| 3A | 32.50 | 2.50 | 65.00 | 0.0128 × 10⁻³ | 0.141 × 10⁻³ | 0.469 × 10⁻³ |
| 3B | 31.25 | 5.00 | 63.75 | 0.0375 × 10⁻³ | 0.315 × 10⁻³ | 0.406 × 10⁻³ |
| 3C | 30.0 | 7.50 | 62.50 | 0.0556 × 10⁻³ | 0.220 × 10⁻³ | 0.521 × 10⁻³ |
| 3D | 28.75 | 10.00 | 61.25 | 0.072 × 10⁻³ | 0.386 × 10⁻³ | 0.565 × 10⁻³ |
| 3E | 27.50 | 12.50 | 60.00 | 0.198 × 10⁻³ | 0.366 × 10⁻³ | 0.523 × 10⁻³ |
| 3F | 26.25 | 15.00 | 58.75 | 0.196 × 10⁻³ | 0.634 × 10⁻³ | 1.360 × 10⁻³ |

### Examples 4A and 4B

In Examples 4A and 4B described below, two working examples of a composite cathode and a polymer electrolyte separator were formulated to determine the ESW of the polymer electrolyte.

### Example 4A

In Example 4A, a polymer electrolyte was prepared using the method for preparation of a polymer electrolyte mixture of the present disclosure. In a first container, cyanoethyl polyvinyl alcohol (CRV) was dissolved in an organic solvent NMP. The CRV mixture was heated and agitated to promote the dissolution of the CRV in the organic solvent. LiBOB, was dried in a vacuum oven at a temperature of 80° C. to 120° C. for approximately 8 hours to remove moisture. SN was distilled to remove any contaminants. In a second container, the SN was dissolved in the organic solvent to form a plasticizer mixture. The plasticizer mixture was then heated and agitated. The dried LiBOB was added to the plasticizer mixture until a homogenous mixture was obtained. The homogenous mixture was then mixed with the CRV mixture. An isophthalonitrile (IPN) was purified through recrystallization. The IPN was then added to the CRV, LiBOB and SN mixture to obtain a mixture 37.5 wt % CRV, 7.5 wt % of LiBOB, 45 wt % SN, and 10 wt % IPN. The CRV, LiBOB, SN, and IPN mixture was then mixed under heat until all components were homogenously distributed.

A slurry was prepared following the method of preparation of a slurry mixture of the polymer electrolyte composite cathode of the present disclosure. A cathode active material, carbon black, and polyvinylidene fluoride binder, and the polymer electrolyte mixture were mixed to form a slurry. The slurry was cast onto an aluminum current collector. The organic solvent NMP was evaporated until a dense, dry, and black film remained. The cast slurry mixture was then flattened onto the current collector using a doctor blade to form a cathode film. The cathode film was then calendared to form a composite cathode.

A polymer electrolyte separator layer was prepared using the method for preparing a solid polymer electrolyte separator using the polymer electrolyte of the present disclosure. The polymer electrolyte mixture was solution cast by means of a dropper. After the polymer electrolyte was solution cast, a film applicator was used to spread the mixture to form an even layer. The organic solvent in the polymer electrolyte mixture was allowed to evaporate over time, eventually solidifying into the polymer electrolyte separator layer.

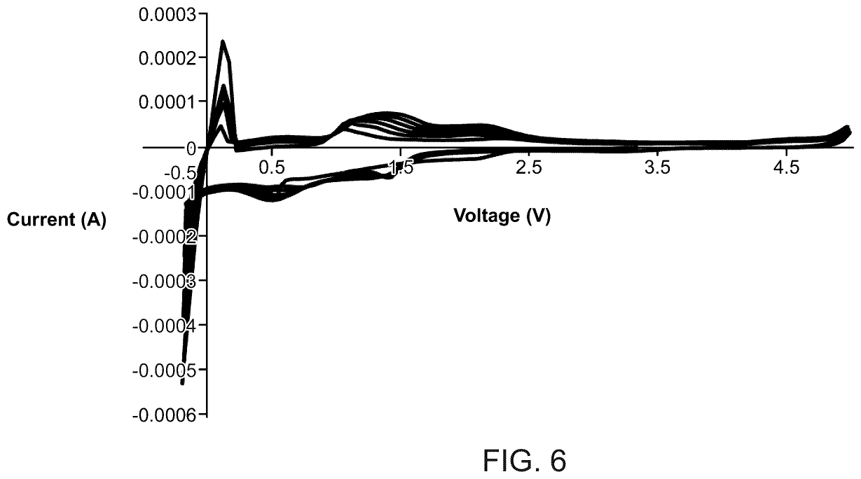

FIG. 6 shows a linear sweep voltammetry (LSV) of the polymer electrolyte as measured and its ESW. The flat areas between both major peaks (far left and far right) indicated a voltage window of 4.7V.

### Example 4B

In Example 4B, a polymer electrolyte was prepared using the method for preparation of a polymer electrolyte mixture of the present disclosure. In a first container, cyanoethyl polyvinyl alcohol (CRV) was dissolved in an organic solvent NMP. The CRV mixture was heated and agitated to promote the dissolution of the CRV in the organic solvent. LiDFOB, was dried in a vacuum oven at a temperature of 80° C. to 120° C. for approximately 8 hours to remove moisture. SN was distilled to remove any contaminants. In a second container, the SN was dissolved in the organic solvent to form a plasticizer mixture. The plasticizer mixture was then heated and agitated. The dried LiDFOB was added to the plasticizer mixture until a homogenous mixture was obtained. The homogenous mixture was then mixed with the CRV mixture. An isophthalonitrile (IPN) was purified through recrystallization. A 1,3-Bis(cyanopropyl)tetramethyldisiloxane (BCTMD), an organosilicon material, was prepared. The IPN and BCTMD were added to the CRV, LiDFOB and SN mixture to obtain a mixture 17.5 wt % CRV, 7.5 wt % LiDFOB, 55 wt % SN, 12.5 wt % IPN, and 7.5 wt % BCTMD. The CRV, LiBOB, SN, IPN, and BCTMD mixture was then mixed under heat until all components were homogenously distributed.

A slurry was prepared following the method of preparation of a slurry mixture of the polymer electrolyte composite cathode of the present disclosure. A cathode active material, carbon black, and polyvinylidene fluoride binder, and the polymer electrolyte mixture were mixed to form a slurry. The slurry was cast onto an aluminum current collector. The organic solvent NMP was evaporated until a dense, dry, and black film remained. The cast slurry mixture was then flattened onto the current collector using a doctor blade to form a cathode film. The cathode film was then calendared to form a composite cathode.

A polymer electrolyte separator layer was prepared using the method for preparing a solid polymer electrolyte separator using the polymer electrolyte of the present disclosure. The polymer electrolyte mixture was solution cast by means of a dropper. After the polymer electrolyte was solution cast, a film applicator was used to spread the mixture to form an even layer. The organic solvent in the polymer electrolyte mixture was allowed to evaporate over time, eventually solidifying into the polymer electrolyte separator layer.

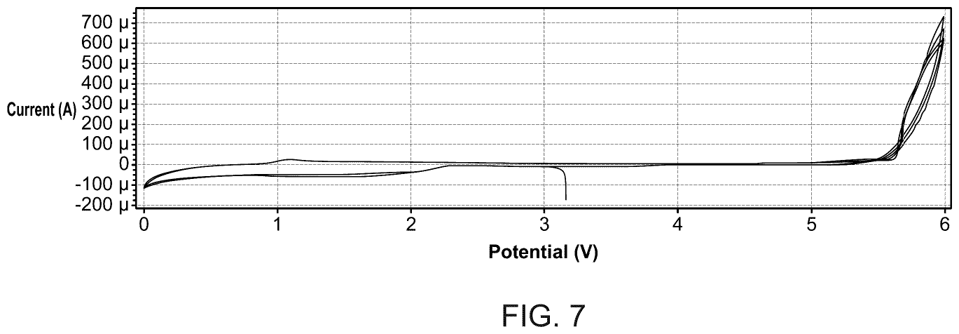

FIG. 7 shows a linear sweep voltammetry (LSV) of the polymer electrolyte as measured and its ESW. The flat areas between both major peaks (far left and far right) indicate a voltage window of 5.5V. The addition of silicon-based BCTMD allowed for an expanded ESW.

### Examples 5A-5F

In Examples 5A-5F, described below, a series of working examples were formulated into a polymer electrolyte with different additives added at varying amounts of the additives for enhancing certain characteristics of the polymer electrolyte, and were tested.

### Example 5A

In Example 5A, a polymer electrolyte was prepared using the method for preparation of a polymer electrolyte mixture of the present disclosure. In a first container, cyanoethyl polyvinyl alcohol (CRV) was dissolved in an organic solvent NMP. The CRV mixture was heated and agitated to promote the dissolution of the CRV in the organic solvent. LiBOB, was dried in a vacuum oven at a temperature of 80° C. to 120° C. for approximately 8 hours to remove moisture. SN was distilled to remove any contaminants. In a second container, the SN was dissolved in the organic solvent to form a plasticizer mixture. The plasticizer mixture was then heated and agitated. The dried LiBOB was added to the plasticizer mixture until a homogenous mixture was obtained. The homogenous mixture was then mixed with the CRV mixture. An isophthalonitrile (IPN) was purified through recrystallization. The IPN was then added to the CRV, LiBOB and SN mixture to obtain a mixture 37.5 wt % CRV, 7.5 wt % of LiBOB, 45 wt % SN, and 10 wt % IPN. The CRV, LiBOB, SN, and IPN mixture was then mixed under heat until all components were homogenously distributed.

A slurry was prepared following the method of preparation of a slurry mixture of the polymer electrolyte composite cathode of the present disclosure. A cathode active material, carbon black, and polyvinylidene difluoride binder, and the polymer electrolyte mixture were mixed to form a slurry. The slurry was cast onto an aluminum current collector. The organic solvent NMP was evaporated until a dense, dry, and black film remained. The cast slurry mixture was then flattened onto the current collector using a doctor blade to form a cathode film. The cathode film was then calendared to form a composite cathode.

A polymer electrolyte separator layer was prepared using the method for preparing a solid polymer electrolyte separator using the polymer electrolyte of the present disclosure. The polymer electrolyte mixture was solution cast by means of a dropper. After the polymer electrolyte was solution cast, a film applicator was used to spread the mixture to form an even layer. The organic solvent in the polymer electrolyte mixture was allowed to evaporate over time, eventually solidifying into the polymer electrolyte separator layer.

The ionic conductivity of the polymer electrolyte separator was measured at 25° C. The polymer electrolyte separator exhibited ionic conductivity of 1.0×10⁻³ S/cm at 25° C.

### Example 5B

In Example 5B, a polymer electrolyte mixture was also prepared using the method for preparation of a polymer electrolyte mixture of the present disclosure. CRV was used as the polymer host, LiDFOB was used as the lithium salt, and SN was used as the plasticizer.

An isophthalonitrile (IPN) was purified through recrystallization. The IPN was then added to the CRV, LiDFOB, and SN mixture. A 2-cyanoethyl ether (CEE) was distilled to remove any contaminants. The CEE was then added to the CRV, LiDFOB, and SN mixture to obtain a mixture of 22.5 wt % CRV, 7.5 wt % LiDFOB, 55 wt % SN, 7.5 wt % IPN, and 7.5 wt % CEE.

The polymer electrolyte of Example 5B was formed into a mechanically stable composite cathode and a mechanically stable polymer electrolyte separator film. A composite cathode was also prepared following the method of preparation of the polymer electrolyte composite cathode of the present disclosure. A polymer electrolyte separator layer was also prepared using the method for preparing a solid polymer electrolyte separator of the present disclosure.

The ionic conductivity of the polymer electrolyte separator was measured at 25° C. The polymer electrolyte separator exhibited ionic conductivity of 8.43×10⁻⁴ S/cm at 25° C.

### Example 5C

In Example 5C, a polymer electrolyte mixture was also prepared using the method for preparation of a polymer electrolyte mixture of the present disclosure. CRV was used as the polymer host, LiDFOB was used as the lithium salt, and SN was used as the plasticizer.

An isophthalonitrile (IPN) was purified through recrystallization. The IPN was then added to the CRV, LiDFOB and SN mixture. A 2-cyanoethyl ether (CEE) was distilled to remove any contaminants. The CEE was then added to the CRV, LiDFOB and SN mixture to obtain a mixture of 17.5 wt % CRV, 7.5 wt % LiDFOB, 55 wt % SN, 12.5 wt % IPN, and 7.5 wt % CEE.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5C was formed into a mechanically stable composite cathode and a mechanically stable polymer electrolyte separator film. The ionic conductivity of the polymer electrolyte separator was measured at 25° C. The polymer electrolyte separator exhibited ionic conductivity of 1.20×10⁻³ S/cm at 25° C.

### Example 5D

In Example 5D, a polymer electrolyte mixture was also prepared using the method for preparation of a polymer electrolyte mixture of the present disclosure. CRV was used as the polymer host, LiDFOB was used as the lithium salt, and SN was used as the plasticizer.

An isophthalonitrile (IPN) was purified through recrystallization. The IPN was then added to the CRV, LiDFOB, and SN mixture. A 1,3-Bis(cyanopropyl)tetramethyldisiloxane (BCTMD) was then added to the CRV, LiDFOB, SN, and IPN mixture to obtain a mixture of 17.5 wt % CRV, 7.5 wt % LiDFOB, 55 wt % SN, 12.5 wt % IPN, and 7.5 wt % BCTMD.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5D was formed into a mechanically stable composite cathode and a mechanically stable polymer electrolyte separator film. The ionic conductivity of the polymer electrolyte separator was measured at 25° C. The polymer electrolyte separator exhibited ionic conductivity of 1.10×10⁻³ S/cm at 25° C.

### Example 5E

In Example 5E, a polymer electrolyte mixture was also prepared using the method for preparation of a polymer electrolyte mixture of the present disclosure. CRV was used as the polymer host, LiDFOB was used as the lithium salt, and SN was used as the plasticizer.

An isophthalonitrile (IPN) was purified through recrystallization. The IPN was then added to the CRV, LiDFOB and SN mixture. A 1,3-Bis(cyanopropyl)tetramethyldisiloxane (BCTMD) was then added to the CRV, LiDFOB, SN, and IPN mixture. A 3,3′-Thiodipropionitrile (TPN) was then added to obtain a mixture of 17.5 wt % CRV, 7.5 wt % LiDFOB, 55 wt % SN, 12.5 wt % IPN, 3.75 wt % BCTMD, and 3.75 wt % TPN.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5E was formed into a mechanically stable composite cathode and a mechanically stable polymer electrolyte separator film. The ionic conductivity of the polymer electrolyte separator was measured at 25° C. The polymer electrolyte separator exhibited ionic conductivity of 2.29×10⁻³ S/cm at 25° C.

### Example 5F

In Example 5F, a polymer electrolyte mixture was also prepared using the method for preparation of a polymer electrolyte mixture of the present disclosure. CRV was used as the polymer host, LiDFOB was used as the lithium salt, and SN was used as the plasticizer.

An isophthalonitrile (IPN) was purified through recrystallization. The IPN was then added to the CRV, LiDFOB and SN mixture. BCTMD was then added to the CRV, LiDFOB, SN, and IPN mixture. A 3,3′-Thiodipropionitrile (TPN) was then added to obtain a mixture of 22.5 wt % CRV, 7.5 wt % LiDFOB, 45 wt % SN, 12.5 wt % IPN, 6.25 wt % BCTMD, and 6.25 wt % TPN.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5F was formed into a mechanically stable composite cathode and a mechanically stable polymer electrolyte separator film. The ionic conductivity of the polymer electrolyte separator was measured at 25° C. The polymer electrolyte separator exhibited ionic conductivity of 4.31×10⁻⁴ S/cm at 25° C.

### Example 5G

In Example 5G, a polymer electrolyte mixture was also prepared using the method for preparation of a polymer electrolyte mixture of the present disclosure. CRV was used as the polymer host, LiDFOB was used as the lithium salt, and SN was used as the plasticizer.

An IPN was then added to the CRV, LiDFOB and SN mixture. BVDS was then added to the CRV, LiDFOB, SN, and IPN mixture. A CEE was then added to obtain a mixture of 22.5 wt % CRV, 7.5 wt % LiDFOB, 55 wt % SN, 7.5 wt % IPN, 2.5 wt % BVDS, and 5.0 wt % CEE.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5G was formed into a mechanically stable composite cathode and a mechanically stable polymer electrolyte separator film. The ionic conductivity of the polymer electrolyte separator was measured at 25° C. The polymer electrolyte separator exhibited ionic conductivity of 8.05×10⁻⁴ S/cm at 25° C.

### Example 5H

In Example 5G, a polymer electrolyte mixture was also prepared using the method for preparation of a polymer electrolyte mixture of the present disclosure. CRV was used as the polymer host, LiDFOB was used as the lithium salt, and SN was used as the plasticizer.

An IPN was then added to the CRV, LiDFOB and SN mixture. BVDS was then added to the CRV, LiDFOB, SN, and IPN mixture. A BCTMD was then added to obtain a mixture of 22.5 wt % CRV, 7.5 wt % LiDFOB, 55 wt % SN, 7.5 wt % IPN, 3.5 wt % BVDS, and 4.0 wt % BCTMD.

A composite cathode was also prepared following the method of preparation of the polymer electrolyte composite cathode of the present disclosure. A polymer electrolyte separator layer was also prepared using the method for preparing a solid polymer electrolyte separator of the present disclosure.

The polymer electrolyte of Example 5H was formed into a mechanically stable composite cathode and a mechanically stable polymer electrolyte separator film. The ionic conductivity of the polymer electrolyte separator was measured at 25° C. The polymer electrolyte separator exhibited ionic conductivity of 1.05× 10⁻³ S/cm at 25° C.

TABLE 5
Summary of Working Examples 5A-5F

| Working | | | Ionic Conductivity |
|---|---|---|---|
| Example | Composition | Wt % | (S/cm) at 25° C. |
| 5A | CRV/LiBOB/SN/IPN | 37.50/7.50/45.00/10.00 | 1.00 × 10⁻³ |
| 5B | CRV/LiDFOB/SN/IPN/CEE | 22.50/7.50/55.00/7.50/7.50 | 8.43 × 10⁻⁴ |
| 5C | CRV/LiDFOB/SN/IPN/CEE | 17.50/7.50/55.00/12.50/7.50 | 1.20 × 10⁻³ |
| 5D | CRV/LiDFOB/SN/IPN/BCTMD | 17.50/7.50/55.00/12.50/7.50 | 1.10 × 10⁻³ |
| 5E | CRV/LiDFOB/SN/IPN/BCTMD/TPN | 17.50/7.50/55.00/12.50/3.75/3.75 | 2.29 × 10⁻³ |
| 5F | CRV/LiDFOB/SN/IPN/BCTMD/TPN | 22.50/7.50/45.00/12.50/6.25/6.25 | 4.31 × 10⁻⁴ |
| 5G | CRV/LiDFOB/SN/IPN/BVDS/CEE | 22.50/7.50/55.00/7.50/2.50/5.00 | 8.05 × 10⁻⁴ |
| 5H | CRV/LiDFOB/SN/IPN/BVDS/BCTMD | 22.50/7.50/55.00/7.50/3.50/4.00 | 1.05 × 10⁻³ |

### Examples 6, 6A, 6B, 7, and 8

In Examples 6, 6A, 6B, 7, and 8, described below, a series of working examples of the polymer electrolyte according to various embodiments of the present disclosure were formulated into a composite cathode and a polymer electrolyte separator and were then integrated into a rechargeable battery cell, and tested.

### Example 6 (LFP)

In Example 6 a polymer electrolyte mixture was also prepared using the method for preparation of a polymer electrolyte mixture of the present disclosure. CRV was used as the polymer host, LiDFOB was used as the lithium salt, and SN was used as the plasticizer. An isophthalonitrile (IPN) was purified through recrystallization. The IPN was then added to the CRV, LIDFOB and SN mixture. A 2-cyanoethyl ether (CEE) was distilled to remove any contaminants. The CEE was then added to the CRV, LiDFOB and SN mixture to obtain a mixture of 22.5 wt % CRV, 7.5 wt % LiDFOB, 55 wt % SN, 7.5 wt % IPN, and 7.5 wt % CEE like the polymer electrolyte in Example 5B.

A slurry and a composite cathode were also prepared following the method of preparation of a slurry mixture of the polymer electrolyte composite cathode of the present disclosure. The cathode active material used for the composite cathode was lithium iron phosphate (LFP). A polymer electrolyte mixture was also prepared using the method for preparing a polymer electrolyte mixture of the present disclosure. The polymer electrolyte separator was then dissolved in acetonitrile (AN) and solution cast on the LFP based composite cathode formed earlier. The AN was evaporated by placing the film into a small antechamber in the glovebox and inducing a slight vacuum. The process was repeated twice to ensure a dense and uniform film deposit on the LFP based composite cathode. After that, a thick Li-metal (500 μm) was placed on top and together with the LFP composite cathode with formed polymer electrolyte layer was assembled into a coin cell. The LFP composite cathode, polymer electrolyte layer, and lithium metal stack were 16 mm in diameter.

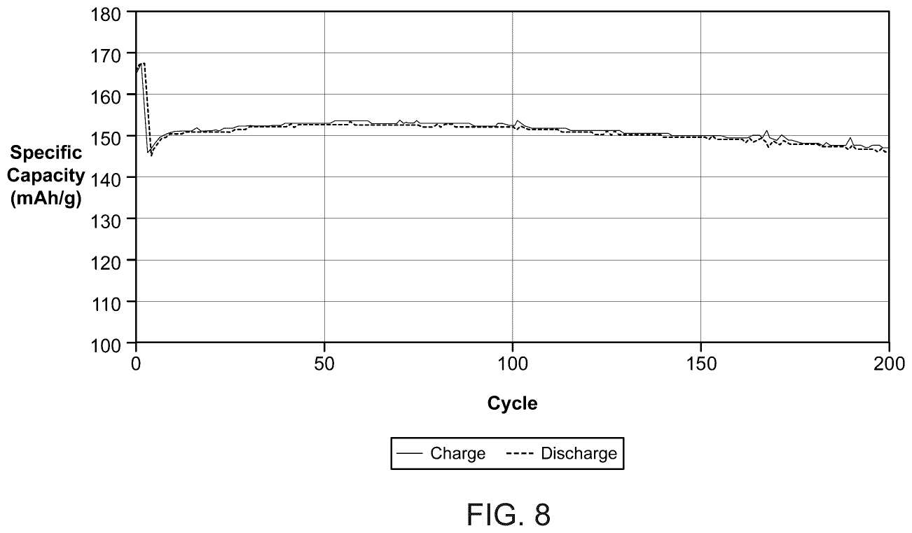

The coin cell was charged and discharged at a 0.05C rate for 2 cycles. The coin cell was then charged and discharged at 1C rate for 200 cycles. FIG. 8 shows the specific capacity of the coin cell for the 202 cycles.

### Example 6A (LFP with Dry Placement)

In Example 6A, the steps for preparing a slurry mixture and a composite cathode were repeated. Like Example 6, the cathode active material used for the composite cathode was lithium iron phosphate (LFP). Like Example 6, a polymer electrolyte mixture was also prepared using the method for preparing a polymer electrolyte mixture of the present disclosure. But different from Example 6, the polymer electrolyte was then cast into a Teflon evaporation dish and the solvent was evaporated. Once evaporated, a polymer electrolyte free-standing membrane was formed, peeled from the dish, and shaped into circular disks having 16 mm in diameter for a coin cell. The circular disk was then dry placed onto the composite cathode. A thick Li-metal (500 μm) was then placed on top of the circular disk. The composite cathode, polymer electrolyte separator layer, and lithium metal anode layer were finally assembled into a coin cell. Another identical coin cell was similarly made.

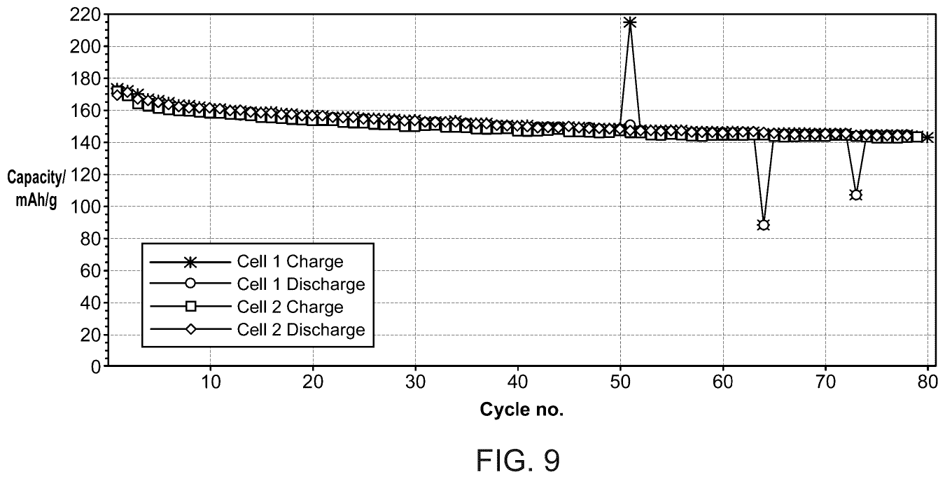

The coin cells were charged and discharged at a 0.2C rate for 80 cycles. FIG. 9 shows the specific capacity of the coin cells for the 80 cycles.

### Example 6B (LFP with Pouch Cell)

In Example 6B, the steps for preparing a slurry mixture and a composite cathode were repeated. Like Example 6, the cathode active material used for the composite cathode was lithium iron phosphate (LFP). Like Example 6, a polymer electrolyte mixture was also prepared using the method for preparing a polymer electrolyte mixture of the present disclosure identical. But different from Example 6, the composite cathode, polymer electrolyte separator layer, and lithium metal anode layer were shaped in a format suitable for a pouch cell. The polymer electrolyte mixture was cast into a Teflon evaporation dish and the solvent was evaporated to form a polymer electrolyte layer. The Teflon evaporation dish is of a size suitable to form a quadrilateral and in this example a 50 mm×50 mm square polymer electrolyte layer was formed. A composite cathode and a lithium metal anode each 50 mm×50 mm were similarly formed.

The composite cathode, polymer electrolyte layer, and lithium metal anode were assembled into a pouch cell using the method for assembly a pouch cell of the present disclosure. A lead tab, which can be made of nickel, was welded to the composite cathode and polymer electrolyte layer piece. The lithium metal anode piece, cut earlier dimensionally to be the same as the composite cathode and the polymer electrolyte layer was layered together to form a unit cell. The unit cell was inserted between two plastic inserts to provide mechanical rigidity. Additionally, an insulating material, which can be made of polyolefin, was wrapped around the entire unit cell and plastic insert assembly. This assembly is then inserted into a heat sealing foil and sealed to form the lithium-ion battery pouch cell.

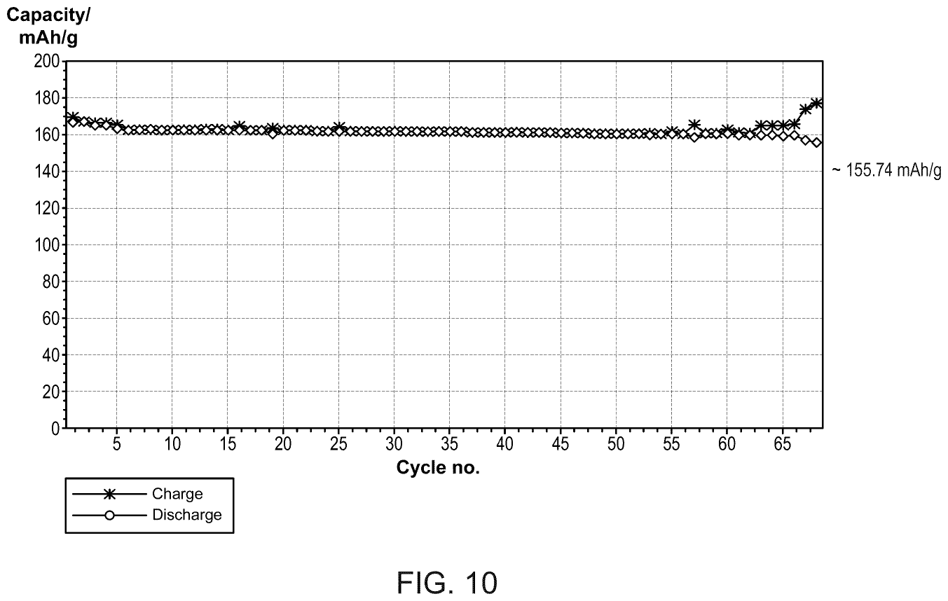

The pouch cell was charged and discharged at a 0.2C rate for 68 cycles. FIG. 10 shows the specific capacity of the pouch cell for the 68 cycles.

### Example 7 (NMC811)

In Example 7 a polymer electrolyte mixture was also prepared using the method for preparation of a polymer electrolyte mixture of the present disclosure. CRV was used as the polymer host, LiDFOB was used as the lithium salt, and SN was used as the plasticizer. An isophthalonitrile (IPN) was purified through recrystallization. The IPN was then added to the CRV, LiDFOB and SN mixture. A 2-cyanoethyl ether (CEE) was distilled to remove any contaminants. A Boron Vinyldimethylsiloxide (BVDS), which contributes to stabilizing the surface chemistry of NMC811 was also prepared. The CEE and BVDS were then added to the CRV, LIDFOB, SN, and IPN mixture to obtain a mixture of 22.5 wt % CRV, 7.5 wt % LiDFOB, 55 wt % SN, 7.5 wt % IPN, 2.5 wt % BVDS, and 5.0 wt % CEE.

A slurry and a composite cathode were then prepared following the method of preparation of a slurry mixture of the polymer electrolyte composite cathode of the present disclosure. The cathode active material used for the composite cathode was lithium nickel manganese cobalt oxide NMC811. A polymer electrolyte mixture was also prepared using the method for preparing a polymer electrolyte mixture of the present disclosure. The polymer electrolyte separator was then dissolved in acetonitrile (AN) and solution cast on the NMC811 based composite cathode formed earlier. The AN was evaporated by placing the film into a small antechamber in the glovebox and inducing a slight vacuum. The process was repeated twice to ensure a dense and uniform film deposit on the NMC811 composite cathode. After that, a thick Li-metal (500 μm) was placed on top and, together with the NMC811 composite cathode with the formed polymer electrolyte layer, was assembled into a coin cell. The NMC811 composite cathode, polymer electrolyte layer, and lithium metal stack were 16 mm in diameter. Another identical coin cell was similarly made.

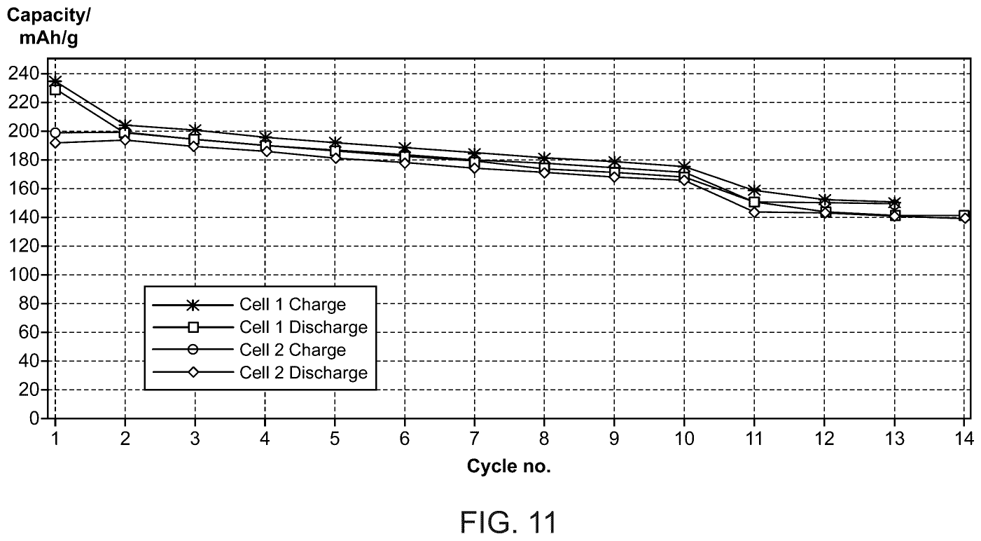

The coin cells were charged and discharged at a C-rate 0.05C for two cycles, 0.1C for eight cycles, and 0.2C for the remaining cycles. The cell was also cycled from 2.8V to 4.3V. FIG. 11 shows the specific capacity of the lithium-ion coin cells during the above charge and discharge cycles.

### Example 8 (LNMO)

In Example 8 a polymer electrolyte mixture was also prepared using the method for preparation of a polymer electrolyte mixture of the present disclosure. CRV was used as the polymer host, LiDFOB was used as the lithium salt, and SN was used as the plasticizer. An isophthalonitrile (IPN) was purified through recrystallization. The IPN was then added to the CRV, LiDFOB, and SN mixture. A 2-cyanoethyl ether (CEE) was distilled to remove any contaminants. A methyl succinic anhydride (MSA), which improves LNMO cathode stability, and a 1,3-Bis(cyanopropyl)tetramethyldisiloxane (BCTMD), which reduces Tg and increases the electrochemical stability window, were prepared. The MSA and BCTMD were then added to the CRV, LIDFOB, SN, and IPN mixture to obtain a mixture of 22.5 wt % CRV, 7.5 wt % LiDFOB, 55 wt % SN, 7.5 wt % IPN, 3.5 wt % MSA, and 4.0 wt % BCTMD.

A slurry and a composite cathode were then prepared following the method of preparation of a slurry mixture of the polymer electrolyte composite cathode of the present disclosure. The cathode active material used for the composite cathode was lithium nickel manganese oxide (LNMO). A polymer electrolyte mixture was also prepared using the method for preparing a polymer electrolyte mixture of the present disclosure. The polymer electrolyte separator was then dissolved in acetonitrile (AN) and solution cast on the LNMO-based composite cathode formed earlier. The AN was evaporated by placing the film into a small antechamber in the glovebox and inducing a slight vacuum. The process was repeated twice to ensure a dense and uniform film deposit on the LMNO composite cathode. After that, a thick Li-metal (500 μm) was placed on top and, together with the LMNO composite cathode with formed polymer electrolyte layer, was assembled into a coin cell. The LMNO composite cathode, polymer electrolyte layer, and lithium metal stack were 16 mm in diameter.

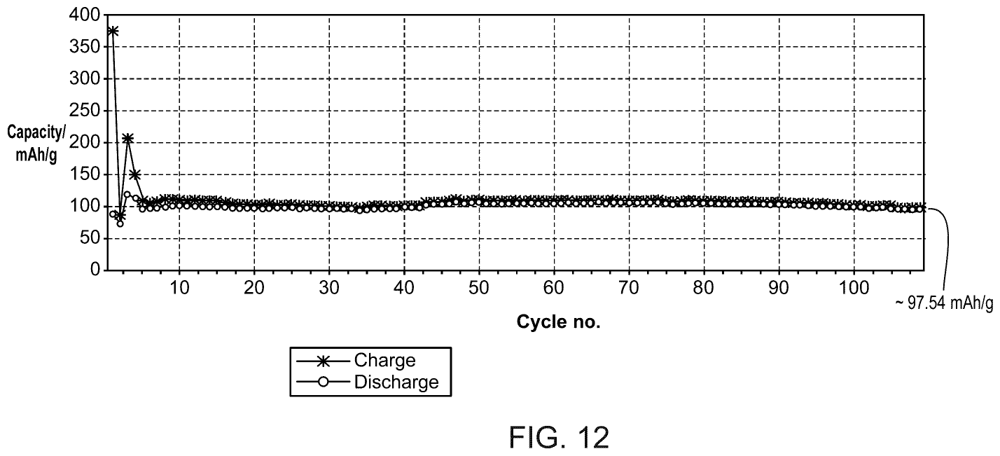

The coin cell was charged and discharged at a C-rate 0.05C for two cycles, and then 0.1C for the remaining cycles. The cell was also cycled from 3.5V to 5V. FIG. 12 shows the specific capacity of the lithium-ion coin cell during the above charge and discharge cycles.

The polymer electrolyte of the present disclosure is comprised of a cyanoresin, a boron-containing lithium salt, and a plasticizer, and can be formed into a free-standing membrane. The cyanoresin can be cyanoethyl polyvinyl alcohol, but also other types of cyanoresins. The boron-containing lithium salt can include LiDFOB or LiBOB. The plasticizer can be a SN. The polymer electrolyte is technically and commercially viable as a catholyte in a composite cathode and as a polymer electrolyte separator, and can together or separately function as components of a solid state or semi-solid rechargeable battery. The polymer electrolyte, as tested, exhibits an ionic conductivity of 1.0×10⁻⁵ S/cm or greater at 25° C. or greater.

Furthermore, because the polymer electrolyte can easily be manufactured into a free-standing membrane, its technical and commercial viability as a catholyte in a composite cathode or as a separator between a cathode and an anode is further enhanced. The composite cathode, using the polymer electrolyte as a catholyte, can be manufactured with relative ease through solution casting the composite cathode directly onto a current collector or other substrate. As a polymer electrolyte separator, the polymer electrolyte can also be solution cast onto the composite cathode or other substrate. Alternatively, the polymer electrolyte separator can be formed without solution casting directly onto the composite cathode. It can be cast onto an entirely different substrate, peeled off, and then dry placed onto the composite cathode. These manufacturing processes, which do not require high pressure, are beneficial over conventional manufacturing processes for solid electrolytes in solid state batteries, which require significant levels of pressure to form the electrolyte. Conventional methods also require integration of the polymer electrolyte into the solid electrolyte material.

The polymer electrolyte of the present disclosure can be formed using different quantities of cyanoresin, boron-containing lithium salt, and plasticizer in various embodiments of the present disclosure to deliver the required ionic conductivity while forming a free-standing membrane. The polymer electrolyte can be supplemented with different additives to tweak its performance.

The composite cathode and polymer electrolyte separator can function together or separately as components of a rechargeable lithium-ion coin cell or pouch cell. The composite cathode and separator can also function with different cathode active materials such as LFP, NMC811, and LMNO. When calibrated with additives, the ESW of the polymer electrolyte can be expanded to accommodate cathode active materials requiring wider ESWs. The composite cathode and polymer electrolyte separator can also be applied to a rechargeable lithium-ion cell with a lithium metal anode.

What is claimed is:

1. A polymer electrolyte, comprising:
a polymer host;
a boron-containing lithium salt; and
a plasticizer,
the polymer host, the boron-containing lithium salt, and the plasticizer formed into a free-standing membrane.

2. The polymer electrolyte of claim 1, wherein the polymer host is a cyanoresin.

3. The polymer electrolyte of claim 1, wherein the boron-containing lithium salt is a lithium difluoro(oxalato)borate.

4. The polymer electrolyte of claim 1, wherein the boron-containing lithium salt is a lithium bis(oxalato)borate.

5. The polymer electrolyte of claim 1, wherein the plasticizer is a succinonitrile.

6. The polymer electrolyte of claim 1, wherein the polymer host is a cyanoresin and the polymer electrolyte comprises 20 wt % to 40 wt % of the cyanoresin.

7. The polymer electrolyte of claim 1, wherein the boron-containing lithium salt is a lithium difluoro(oxalato)borate and the polymer electrolyte comprises 2.5 wt % to 15 wt % of the lithium difluoro(oxalato)borate.

8. The polymer electrolyte of claim 1, wherein the boron-containing lithium salt is a lithium bis(oxalato)borate and the polymer electrolyte comprises 2.5 wt % to 15 wt % of the lithium bis(oxalato)borate.

9. The polymer electrolyte of claim 1, wherein the plasticizer is a succinonitrile and the polymer electrolyte comprises 45 wt % to 72.5 wt % of the succinonitrile.

10. The polymer electrolyte of claim 1, wherein the polymer electrolyte has an ionic conductivity greater than 1×10⁻⁵ S/cm.

11. The polymer electrolyte of claim 10, wherein the ionic conductivity is provided at a temperature greater than or equal to 25° C.

12. The polymer electrolyte of claim 1, further comprising an isophthalonitrile.

13. The polymer electrolyte of claim 1, further comprising an isophthalonitrile and a 2-cyanoethyl ether.

14. The polymer electrolyte of claim 1, further comprising an isophthalonitrile and a 1,3-Bis(cyanopropyl)tetramethyldisiloxane.

15. The polymer electrolyte of claim 1, further comprising an isophthalonitrile, a 1,3-Bis(cyanopropyl)tetramethyldisiloxane, and a 3,3′-thiodipropionitrile.

16. A polymer electrolyte, comprising:
a cyanoethyl polyvinyl alcohol;
a lithium difluoro(oxalato)borate; and
a succinonitrile,
wherein the polymer electrolyte comprises 20 wt % to 40 wt % of the cyanoethyl polyvinyl alcohol, 2.5 wt % to 15 wt % of the lithium difluoro(oxalato)borate, and 45 wt % to 72.5 wt % of the succinonitrile.

17. A method of manufacturing a polymer electrolyte, comprising:
dissolving a polymer host in a first organic solvent;
heating the polymer host to promote dissolution of the polymer host in the organic solvent to form a polymer host mixture;
drying a boron-containing lithium salt at a temperature to remove moisture to form a dried boron-containing lithium salt;
dissolving a plasticizer in a second organic solvent to form a plasticizer mixture;
heating the plasticizer mixture;
adding the dried boron-containing lithium salt to the plasticizer mixture to obtain a first mixture;
mixing the polymer host mixture to the first mixture to obtain a polymer electrolyte mixture; and
forming the polymer mixture into a free-standing membrane.

18. The method of claim 17, wherein the boron-containing lithium salt is dried at 80° C. to 120° C.

19. The method of claim 17, wherein the polymer host is a cyanoresin.

20. The method of claim 17, wherein the boron-containing lithium salt is a lithium difluoro(oxalato)borate.

21. The method of claim 17, wherein the boron-containing lithium salt is a lithium bis(oxalato)borate.

22. The method of claim 17, wherein the plasticizer is a succinonitrile.

23. The method of claim 17, wherein the polymer host is a cyanoresin and the polymer electrolyte comprises 20 wt % to 40 wt % of the cyanoresin.

24. The method of claim 17, wherein the boron-containing lithium salt is a lithium difluoro(oxalato)borate and the polymer electrolyte comprises 2.5 wt % to 15 wt % of the lithium difluoro(oxalato)borate.

25. The method of claim 17, wherein the boron-containing lithium salt is a lithium bis(oxalato)borate and the polymer electrolyte comprises 2.5 wt % to 15 wt % of the lithium bis(oxalato)borate.

26. The method of claim 17, wherein the plasticizer is a succinonitrile and the polymer electrolyte comprises 45 wt % to 72.5 wt % of the succinonitrile.

27. The method of claim 17, wherein the polymer electrolyte has an ionic conductivity greater than 1×10⁻⁵ S/cm.

28. The method of claim 27, wherein the ionic conductivity is provided at a temperature greater than or equal to 25° C.

29. The method of claim 17, further comprising adding an isophthalonitrile to the first mixture.

30. The method of claim 17, further comprising adding an isophthalonitrile and a 2-cyanoethyl ether to the first mixture.

31. The method of claim 17, further comprising adding an isophthalonitrile and a 1,3-Bis(cyanopropyl)tetramethyldisiloxane to the first mixture.

32. A method of manufacturing a polymer electrolyte, comprising:
dissolving a cyanoresin in a first organic solvent;
heating the cyanoresin to promote dissolution of the cyanoresin in the organic solvent to form a cyanoresin mixture;
drying a lithium difluoro(oxalato)borate at a temperature to remove moisture to form a dried lithium difluoro(oxalato)borate;
dissolving a succinonitrile in a second organic solvent to form a succinonitrile mixture;
heating the succinonitrile mixture;
adding the dried lithium difluoro(oxalato)borate to the succinonitrile mixture to obtain a first mixture; and
mixing the cyanoresin mixture to the first mixture to obtain a polymer electrolyte mixture that comprises the cyanoresin, the lithium difluoro(oxalato)borate, and the succinonitrile; and
forming the polymer electrolyte mixture into a free-standing membrane.

33. The method of claim 32, wherein the polymer host is a cyanoresin and the polymer electrolyte comprises 20 wt % to 40 wt % of the cyanoresin.

34. The method of claim 32, wherein the boron-containing lithium salt is a lithium difluoro(oxalato)borate and the polymer electrolyte comprises 2.5 wt % to 15 wt % of the lithium difluoro(oxalato)borate.

35. The method of claim 32, wherein the boron-containing lithium salt is a lithium bis(oxalato)borate and the polymer electrolyte comprises 2.5 wt % to 15 wt % of the lithium bis(oxalato)borate.

36. The method of claim 32, wherein the plasticizer is a succinonitrile and the polymer electrolyte comprises 45 wt % to 72.5 wt % of the succinonitrile.

37. A composite cathode for a rechargeable battery cell, comprising:
a cathode active material;
a carbon-containing material;
a polymer electrolyte, comprising:
a polymer host;
a boron-containing lithium salt;
a plasticizer; and
a polyvinylidene fluoride binder binding the cathode active material, the carbon-containing material, and the polymer electrolyte;
wherein the cathode active material, the carbon-containing material, the polyvinylidene fluoride binder, and the polymer electrolyte are formed as a cathode film; and
the cathode film is formed on a current collector.

38. The composite cathode of claim 37, wherein the polymer electrolyte functions as a catholyte.

39. The composite cathode of claim 37, wherein the polymer host is a cyanoresin and the polymer electrolyte comprises 20 wt % to 40 wt % of the cyanoresin.

40. The composite cathode of claim 37, wherein the boron-containing lithium salt is a lithium difluoro(oxalato)borate and the polymer electrolyte comprises 2.5 wt % to 15 wt % of the lithium difluoro(oxalato)borate.

41. The composite cathode of claim 37, wherein the boron-containing lithium salt is a lithium bis(oxalato)borate and the polymer electrolyte comprises 2.5 wt % to 15 wt % of the lithium bis(oxalato)borate.

42. The composite cathode of claim 37, wherein the plasticizer is a succinonitrile and the polymer electrolyte comprises 45 wt % to 72.5 wt % of the succinonitrile.

43. The composite cathode of claim 37, wherein the polymer electrolyte has an ionic conductivity greater than 1×10⁻⁵ S/cm.

44. The composite cathode of claim 43, wherein the ionic conductivity of the polymer electrolyte is provided at a temperature greater than or equal to 25° C.

45. The composite cathode of claim 37, wherein the polymer electrolyte further comprises an isophthalonitrile.

46. The composite cathode of claim 37, wherein the polymer electrolyte further comprises an isophthalonitrile and a 2-cyanoethyl ether.

47. The composite cathode of claim 37, wherein the polymer electrolyte further comprises an isophthalonitrile and a 1,3-Bis(cyanopropyl)tetramethyldisiloxane.

48. The composite cathode of claim 37, wherein the polymer electrolyte further comprises an isophthalonitrile, a 1,3-Bis(cyanopropyl)tetramethyldisiloxane, and a 3,3′-Thiodipropionitrile.

49. The composite cathode of claim 37, wherein the cathode active material is a lithium iron phosphate.

50. The composite cathode of claim 37, wherein the cathode active material is a lithium nickel manganese cobalt oxide (NMC) and more than 50% of the nickel manganese cobalt oxide is nickel.

51. The composite cathode of claim 37, wherein the cathode active material is a lithium nickel manganese oxide.

52. A polymer electrolyte separator, comprising:
a polymer electrolyte, comprising:
a cyanoresin;
a boron-containing lithium salt; and
a succinonitrile;
the polymer electrolyte formed as at least one solid layer, the at least one solid layer immediately adjacent to a cathode layer and an anode layer.

53. The polymer electrolyte separator of claim 52, wherein the solid layer is formed by dry placing the solid layer between the cathode layer and the anode layer.

54. An electrode stack, comprising:
a positive current collector layer;
a cathode film layer formed on the current collector layer;
a polymer electrolyte separator layer that comprises a cyanoresin, a boron-containing lithium salt, and a succinonitrile, the polymer electrolyte separator layer formed on the cathode film layer; and
an anode layer separated from the cathode layer by the polymer electrolyte layer, the anode layer formed on a negative current collector.

55. A method for manufacturing a composite cathode, comprising:
preparing a polymer electrolyte, by
dissolving a polymer host in a first organic solvent;
heating the polymer host to promote dissolution of the polymer host in the organic solvent to form a polymer host mixture;
drying a boron-containing lithium salt at a temperature to remove moisture to form a dried boron-containing lithium salt;
dissolving a plasticizer in a second organic solvent to form a plasticizer mixture;
heating the plasticizer mixture;
adding the dried boron-containing lithium salt to the plasticizer mixture to obtain a first mixture;
mixing the polymer host mixture to the first mixture to obtain a polymer electrolyte mixture comprising the polymer host, the boron-containing lithium salt, and the plasticizer;
mixing the polymer electrolyte with a cathode active material, a carbon-containing material, and a polyvinylidene fluoride binder to form a slurry mixture;
casting the slurry mixture on a current collector;
spreading the slurry mixture on the current collector;
removing the solvent in the slurry mixture to form a cathode film layer; and
calendaring the cathode film layer and the current collector.

56. The method for manufacturing the composite cathode of claim 55, wherein the cathode film layer and the current collector are calendared to increase the density of the cathode film layer to 1.7 g/cm³.

57. A method of manufacturing a polymer electrolyte separator, comprising:
preparing a polymer electrolyte, by
dissolving a polymer host in a first organic solvent;
heating the polymer host to promote dissolution of the polymer host in the organic solvent to form a polymer host mixture;
drying a boron-containing lithium salt at a temperature to remove moisture to form a substantially dried boron-containing lithium salt;
dissolving a plasticizer in a second organic solvent to form a plasticizer mixture;
heating the plasticizer mixture;
adding the dried boron-containing lithium salt to the plasticizer mixture to obtain a first mixture;
mixing the polymer host mixture to the first mixture to obtain a polymer electrolyte mixture comprising the polymer host, the boron-containing lithium salt, and the plasticizer; and
forming the polymer electrolyte as a free-standing membrane on a substrate;
removing the free-standing membrane from the substrate;
dry placing the free-standing membrane on an electrode layer.

58. A method of manufacturing an electrode stack, comprising:
forming a composite cathode by,
preparing a polymer electrolyte that comprises a cyanoresin, a boron-containing lithium salt, and a plasticizer;
mixing the polymer electrolyte with a cathode active material, a carbon-containing material, and a polyvinylidene fluoride binder to form a slurry mixture;
casting the slurry mixture on a current collector;
spreading the slurry mixture on the current collector;
removing the solvent in the slurry mixture to form a cathode film layer; and
calendaring the cathode film layer and current collector;
forming a polymer electrolyte separator by,
preparing a polymer electrolyte; and
forming at least one solid layer of the polymer electrolyte on the composite cathode;
forming an anode layer on a negative current collector;
stacking the anode layer and negative current collector on the polymer electrolyte separator.

59. The method of claim 58, wherein the solid layer of the polymer electrolyte is formed by dry placing on the composite cathode.

60. A rechargeable battery cell comprising:
a plurality of electrode sub-stacks sealed in an insulative body, each of the electrode sub-stacks including:
a composite cathode layer formed on a first current collector to form a positive electrode, wherein the cathode layer is a composite cathode;
an anode layer formed on a second current collector to form a negative electrode, wherein the anode layer is a lithium metal; and
at least one polymer electrolyte separator layer, the at least one polymer electrolyte separator layer immediately adjacent to the positive electrode and the negative electrode;
wherein the composite cathode layer, the anode layer, and the polymer electrolyte separator are solid.

61. The rechargeable battery cell of claim 60, wherein the rechargeable battery cell does not contain any liquid electrolyte.

62. The rechargeable battery cell of claim 60, wherein the polymer electrolyte separator is formed as a free-standing membrane.

63. The rechargeable battery cell of claim 60, wherein the composite cathode layer comprises:
a cathode active material;
a carbon-containing material;
a polyvinylidene fluoride binder; and
a polymer electrolyte, including:
a cyanoresin;
a boron-containing lithium salt; and
a succinonitrile.

64. The rechargeable battery cell of claim 60, wherein the polymer electrolyte separator layer comprises:
a cyanoresin;
a boron-containing lithium salt; and
a succinonitrile,
wherein the polymer electrolyte separator is formed as a solid layer on the composite cathode.

65. The rechargeable battery cell of claim 63, wherein the cathode active material is a lithium iron phosphate.

66. The rechargeable battery cell of claim 63, wherein the cathode active material is a lithium nickel manganese cobalt oxide with a nickel content greater than 50% of the cathode active material.

67. The rechargeable battery cell of claim 63, wherein the cathode active material is a lithium nickel manganese oxide.

68. A method for manufacturing a rechargeable battery cell, comprising:
stacking a plurality of electrode sub-stacks to form a full electrode stack, wherein stacking each of the plurality of electrode sub-stacks includes:
casting a cathode layer on a first current collector to form a positive electrode, wherein the cathode layer is a composite cathode;
depositing an anode layer on a second current collector to form a negative electrode, wherein the anode layer is a lithium metal;
forming a solid polymer electrolyte separator layer on the cathode layer;
stacking the anode layer facing the polymer electrolyte separator layer; and
stacking the positive electrode, negative electrode, and polymer electrolyte separator to form an electrode sub-stack.

69. The method of claim 68, wherein the polymer electrolyte separator layer is formed by solution casting.

70. The method of claim 68, wherein the solid polymer electrolyte separator layer is formed by dry placement.
